(19) United States
(12) Patent Application Publication
(10) Pub. No.: US 2026/0093190 A1
(43) Pub. Date: Apr. 2, 2026

(54) ELECTROPHOTOGRAPHIC PHOTOSENSITIVE MEMBER, PROCESS CARTRIDGE, ELECTROPHOTOGRAPHIC APPARATUS, AND METHOD FOR PRODUCING ELECTROPHOTOGRAPHIC PHOTOSENSITIVE MEMBER

(71) Applicant: CANON KABUSHIKI KAISHA, Tokyo (JP)

(72) Inventors: TAICHI SATO, Shizuoka (JP); NAO HIGUCHI, Shizuoka (JP); KENTARO TANAKA, Shizuoka (JP); SHUNTARO WATANABE, Kanagawa (JP); TSUTOMU NISHIDA, Shizuoka (JP)

(21) Appl. No.: 19/084,331

(22) Filed: Mar. 19, 2025

(30) Foreign Application Priority Data
Mar. 28, 2024 (JP) 2024-053994
Feb. 14, 2025 (JP) 2025-022740

(51) Int. Cl. G03G 5/147; G03G 5/05; G03G 21/18

(52) U.S. Cl. CPC G03G 5/14752; G03G 5/0525; G03G 5/14704; G03G 5/14734; G03G 5/14773; G03G 21/18

(57) ABSTRACT

To provide an electrophotographic photosensitive member having high cleanability and hardly causing image blurring to occur even in use in a high-temperature and high-humidity environment. An electrophotographic photosensitive member having a surface layer containing a binder resin, wherein the surface layer contains a polydimethylsiloxane having a polyester chain, and oleamide.

### BACKGROUND OF THE INVENTION

### Field of the Invention

The present invention relates to an electrophotographic photosensitive member, a process cartridge having the electrophotographic photosensitive member, an electrophotographic apparatus, and a method for producing an electrophotographic photosensitive member.

### Description of the Related Art

In recent years, in the field of electrophotographic apparatuses such as photocopiers or printers, high-speed printing is demanded to increase the productivity of electrophotographic apparatuses. Along with an increase in speeds of electrophotographic apparatuses, rubbing speed between a cleaning member and an electrophotographic photosensitive member increases.

Thus, when a cleaning member vibrates or a surface of an electrophotographic photosensitive member is damaged, so-called cleaning defects such that transfer residual toner on the electrophotographic photosensitive member passes through the cleaning member may occur.

To solve the above problem, measures such that cleanability is imparted to an electrophotographic photosensitive member by devising the surface layer of the electrophotographic photosensitive member have been made. For example, Japanese Patent Application Laid-Open No. 2012-123379 discloses a technique for maintaining high cleanability for a long term without causing filming and image defects by containing a resin having a polydimethylsiloxane structure in the surface layer of the electrophotographic photosensitive member.

However, electrophotographic apparatuses in recent years have widely become common and increasingly used in various environments accordingly. According to the studies of the present inventors, it has been found that, while cleanability is ensured under durable conditions in a technique described in Japanese Patent Application Laid-Open No. 2012-123379, image blurring occurs in use in a high-temperature and high-humidity environment, which is problematic.

Therefore, an object of the present invention is to provide an electrophotographic photosensitive member that causes no image blurring to occur even at high temperature and high humidity while maintaining high cleanability. Moreover, an object of the present invention is to provide a method for producing the electrophotographic photosensitive member.

### SUMMARY OF THE INVENTION

The above objects are achieved by the present invention below.

That is, the present invention provides an electrophotographic photosensitive member having a surface layer containing a binder resin, wherein the surface layer contains a polydimethylsiloxane having a polyester chain, and oleamide (oleic acid amide).

The present invention also provides a process cartridge integrally supporting the above electrophotographic photosensitive member and at least one unit selected from the group consisting of a charging unit, a developing unit and a cleaning unit, and being detachable from the body of an electrophotographic apparatus.

The present invention also provides an electrophotographic apparatus having the above electrophotographic photosensitive member, a charging unit, an exposure unit, a developing unit and a transfer unit.

The present invention also provides a method for producing an electrophotographic photosensitive member having a surface layer, the method including a preparation step of preparing a coating liquid for the surface layer, an application step of applying the coating liquid, and a solidification step of drying or curing the applied coating liquid, wherein the coating liquid contains a polydimethylsiloxane having a polyester chain, and oleamide.

Further features of the present invention will become apparent from the following description of exemplary embodiments with reference to the attached drawings.

### BRIEF DESCRIPTION OF THE DRAWINGS

FIG. 1A is an example of a layer structure of the electrophotographic photosensitive member according to the present invention. FIG. 1B is another example of a layer structure of the electrophotographic photosensitive member according to the present invention.

FIG. 2 is a diagram of an exemplary schematic configuration of the electrophotographic apparatus having a process cartridge including the electrophotographic photosensitive member of the present invention.

FIG. 3 is a diagram of an exemplary schematic configuration of the process cartridge including the electrophotographic photosensitive member of the present invention.

### DESCRIPTION OF THE EMBODIMENTS

Preferred embodiments of the present invention will now be described in detail in accordance with the accompanying drawings.

### First Embodiment

The first embodiment relates to an electrophotographic photosensitive member. The electrophotographic photosensitive member of the present invention is an electrophotographic photosensitive member having a surface layer containing a binder resin, wherein the surface layer contains a polydimethylsiloxane having a polyester chain, and oleamide. Hereinafter, preferred embodiments of the present invention will be described.

### [Electrophotographic Photosensitive Member]

The electrophotographic photosensitive member of the present invention has a surface layer containing a binder resin.

Here, the surface layer refers to a layer positioned at the outermost surface in the electrophotographic photosensitive member, and means a layer brought into contact with a charging member, a toner, or a cleaning member.

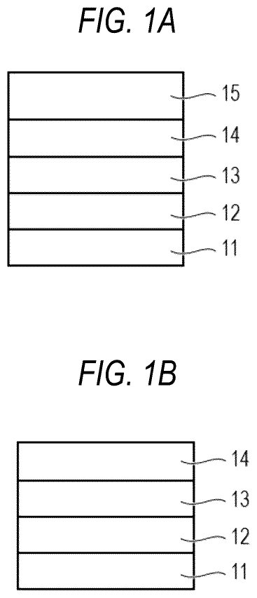

Each of FIG. 1A and FIG. 1B is a diagram illustrating an example of a layer structure of the electrophotographic photosensitive member. The electrophotographic photosensitive member in FIG. 1A has a support 11, an undercoat layer 12, a charge generation layer 13, a charge transport layer 14 and an overcoat layer 15. The electrophotographic photosensitive member in FIG. 1B has the support 11, the undercoat layer 12, the charge generation layer 13 and the charge transport layer 14.

The electrophotographic photosensitive member of the present invention may also be a belt-like shape or a sheet-like shape.

The electrophotographic photosensitive member of the present invention is used in an image formation method including a charging step of charging the surface of the electrophotographic photosensitive member, an exposure step of exposing the charged electrophotographic photosensitive member to form an electrostatic latent image, a development step of supplying toner to the electrophotographic photosensitive member on which the electrostatic latent image is formed to form a toner image, and a transfer step of transferring the toner image formed on the electrophotographic photosensitive member.

Hereinafter, the support and each layer will be described.

### <Surface Layer>

The surface layer as used herein is a part where the electrophotographic photosensitive member is brought into contact with the toner or various members in the electrophotographic process. Although an overcoat layer, a charge transport layer and a single-layered photosensitive layer may be the surface layer, the surface layer is preferably an overcoat layer, from a viewpoint of achieving both the durability in repeated use for a long lifetime and basic electrical characteristics in an electrophotographic process.

According to the studies by the present inventor, it is required to satisfy that the surface layer contain a binder resin, a polydimethylsiloxane having a polyester chain (also referred to as a polyester-modified polydimethylsiloxane), and oleamide, to suppress image blurring while ensuring high cleanability.

For the method for producing an electrophotographic photosensitive member for suppressing image blurring while ensuring high cleanability, the coating liquid for the surface layer is required to contain a polydimethylsiloxane having a polyester chain, and oleamide.

A reason why an effect of the present invention can be exerted by the above conditions is not clearly demonstrated, but the present inventor presumes as follows.

The suppression of image blurring described above is considered as follows.

In the charging step, oxidized gas such as ozone or nitrogen oxide is generated by discharge between the electrophotographic photosensitive member and the charging member, and the oxidized gas deteriorates the material used in the surface layer of the electrophotographic photosensitive member to generate a discharge product. When the discharge product adsorbs the moisture in air, so-called image blurring in which the electrostatic latent image formed on the electrophotographic photosensitive member is broken may occur.

In this case, since the resistance of the surface layer of the electrophotographic photosensitive member is reduced due to moisture adsorption, image blurring occurs more significantly. When the polyester-modified polydimethylsiloxane is contained in the coating liquid for the surface layer of the electrophotographic photosensitive member, the polydimethylsiloxane component acts as a surfactant upon coating of the surface layer, and the polyester-modified polydimethylsiloxane is likely to migrate to the outermost surface.

Thus, while cleanability is ensured, the H₂O molecule is likely to be adsorbed on an ester bond moiety included in the polyester-modified polydimethylsiloxane. Thus, it is considered that the reduction in the resistance of the outermost surface layer promotes the occurrence of image blurring.

On the other hand, oleamide is likely to migrate to the surface due to having a long-chain hydrocarbon group, and is likely to be adsorbed on the ester bond included in the polyester-modified polydimethylsiloxane due to having an amide group at the end.

Further, since oleamide has a long chain length of a hydrocarbon that is hardly bonded to the H₂O molecule and having a double bond on the central portion of the hydrocarbon chain, oleamide has a structure in which the long hydrocarbon chain of oleamide is hardly entangled.

Thus, oleamide can maintain a large steric hindrance, while adsorbing on the ester bond moiety on which the H₂O molecule is likely to be adsorbed. Thus, when the polyester-modified polydimethylsiloxane that ensures cleanability and oleamide are contained in the surface layer, the adsorption of the H₂O molecule on the ester bond moiety of the polyester-modified polydimethylsiloxane can be prevented.

As a result, it is considered that the reduction in the resistance of the surface layer is suppressed even in a high-temperature and high-humidity environment, so that image blurring is hardly occur and high cleanability can also be achieved.

In the electrophotographic photosensitive member of the present invention, the surface layer preferably contains a metal oxide particle. When a metal oxide particle is contained in the surface layer, the effect of the present invention is significant. This is because metal oxides have a very low volume resistivity as compared with resins and organic materials bearing a function of charge transport, so that the volume resistivity of the entire surface layer is reduced.

Thus, it is inferred that an influence of the reduction in the resistance of the resin part due to moisture adsorption is large, and image blurring is likely to occur. In the electrophotographic photosensitive member of the present invention, the metal oxide particle preferably contains a tin atom, and is more preferably an ITO particle.

When the charge transport performance of the surface layer is ensured by the metal oxide particle, an amount thereof to be filled is required to be adjusted depending on the powder resistivity of the metal oxide particle. In a case of a metal oxide particle having a low powder resistivity, the amount to be filled may be low, but in the case of a metal oxide particle having a high powder resistivity, a high amount of volume to be filled is required.

Since the electrophotographic photosensitive member forms an electric latent image by irradiating the photosensitive layer with laser, a high amount of the metal oxide particle in the surface layer to be filled reduces light transmissivity of the surface layer, leading to a reduction in sensibility of the electrophotographic photosensitive member. Thus, a low powder resistivity that enables charge transport performance to be exerted with a low amount to be filled is preferable. The powder resistivity is preferably 10² Ω·cm or less, and more preferably 10¹ Ω·cm or less.

The surface layer of the electrophotographic photosensitive member of the present invention contains a polydimethylsiloxane having a polyester chain, and oleamide. The content of the polyester-modified polydimethylsiloxane in the surface layer is preferably 0.10% by mass or more and 1.0% by mass or less, except for the metal oxide particle in the surface layer.

With a content less than 0.1% by mass, it is difficult to ensure sufficient cleanability, and with a content more than 1.0% by mass, an image defect is likely to occur in a high-temperature and high-humidity environment on a contact member with the electrophotographic photosensitive member, in particular, on a contact portion with a charging roller.

In the present invention, a common chemical substance such as oleamide can be confirmed by, for example, the nuclear magnetic resonance method (NMR) and gas chromatography mass spectrometry (GC-MS).

In the present invention, the polydimethylsiloxane having a polyester chain is preferably a polyester-modified polydimethylsiloxane, and more preferably a compound represented by the following formula (B):

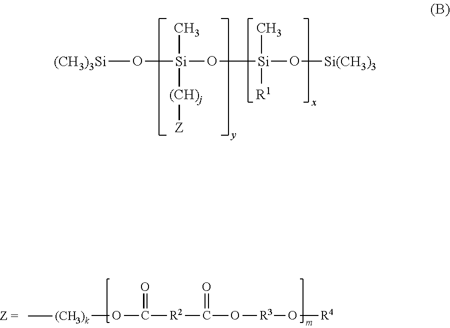

wherein R¹ is an aliphatic hydrocarbon group having 1 or more and 15 or less carbon atoms, R² is an aliphatic hydrocarbon group having 1 or more and 15 or less carbon atoms or an aromatic hydrocarbon group, R³ is an aliphatic hydrocarbon group having 1 or more and 15 or less carbon atoms or an aromatic hydrocarbon group, R⁴ is an aliphatic hydrocarbon group having 1 or more and 15 or less carbon atoms or an aromatic hydrocarbon group, x is an integer of 1 to 300, y is an integer of 1 to 100, j is an integer of 1 to 15, k is an integer of 0 to 5, and m is an integer of 1 to 20. In the present invention, the compound represented by the formula (B) can be confirmed by NMR, GC-MS and matrix assisted laser desorption/ionization mass spectrometry (MALDI-MS).

The electrophotographic photosensitive member of the present invention preferably has a content of oleamide of 40 parts by mass or more and 160 parts by mass or less based on 100 parts by mass of the polyester-modified polydimethylsiloxane, in the surface layer. With a content of less than 40 parts by mass, an adsorption of H₂O molecule on ester bond moiety of polyester-modified polydimethylsiloxane cannot be sufficiently suppressed, and suppression of image blurring is small. With a content of more than 160 parts by mass, an image defect is likely to occur in a high-temperature and high-humidity environment on a contact member with the electrophotographic photosensitive member, in particular, on a contact portion with a charging roller.

The binder resin in the surface layer is preferably a polymerization-cured film such as an acrylic resin, an epoxy resin, a phenolic resin, or a melamine resin, and more preferably a polymerization-cured film of a composition containing a (meth)acrylic compound.

This is because the polymerization-cured film increases film strength and enables the surface layer to be prevented from being shaved, and a reduction in molecular mobility enables the reduction in resistance of film resistance upon adsorption of the moisture to be suppressed. The (meth)acrylic compound is more preferably a polymerization-cured film of a tetrafunctional to hexafunctional (meth)acrylic monomer, and further preferably a hexafunctional urethane (meth) acrylic monomer.

Further, the polyester-modified polydimethylsiloxane preferably contains a (meth)acrylic group. When the binder resin in the surface layer is a polymerization-cured film of the composition containing a (meth)acrylic compound, the (meth)acrylic group in polyester-modified polydimethylsiloxane reacts with the polymerization-cured film and is fixed, so that high cleanability can be maintained for a long term.

In the electrophotographic photosensitive member of the present invention, Martens hardness of the surface layer is preferably 150 N/mm² or more and 300 N/mm² or less. When the Martens hardness is less than 150 N/mm², wear resistance deteriorates, and when it is more than 300 N/mm², the surface layer is fragile and a crack or chipping may occur. The Martens hardness of the surface layer can be measured by a method described in ISO14577.

### <Support>

In the present invention, the electrophotographic photosensitive member has a support. In the present invention, the support is preferably a conductive support having conductivity. Examples of the shape of the support include cylindrical, belt-like, and sheet-like shapes. Among them, a cylindrical support is preferable. In addition, the surface of the support may be subjected to electrochemical treatment such as anodization; blast treatment; cutting treatment; or etc.

The material of the support is preferably a metal, a resin, glass, or etc.

Examples of the metal include aluminum, iron, nickel, copper, gold, stainless, and alloys thereof. Among them, a support made of aluminum using aluminum is preferable.

Conductivity may be imparted to the resin or glass by treatment such as mixing or coating with a conductive material.

### <Conductive Layer>

In the electrophotographic photosensitive member used in the present invention, a conductive layer may be provided on the support. By providing the conductive layer, a scratch or unevenness on the support surface can be covered, and the reflection of light on the support surface can be controlled.

The conductive layer preferably contains a conductive particle and a resin.

Examples of the material of the conductive particle include metal oxides, metals and carbon black.

Examples of the metal oxide include zinc oxide, aluminum oxide, indium oxide, silicon oxide, zirconium oxide, tin oxide, titanium oxide, magnesium oxide, antimony oxide and bismuth oxide. Examples of the metal include aluminum, nickel, iron, nichrome, copper, zinc and silver.

Among them, a metal oxide is preferably used as the conductive particle, and in particular, titanium oxide, tin oxide, or zinc oxide is more preferably used.

When the metal oxide is used as the conductive particle, the surface of the metal oxide may be treated with a silane coupling agent or etc., or the metal oxide may be doped with an element such as phosphorous or aluminum or an oxide thereof. The element to be doped and the oxide thereof include phosphorous, aluminum, niobium and tantalum.

The conductive particle may have a multilayer structure having a core particle and a coating layer for coating the particle. Examples of the core particle include titanium oxide, barium sulfate and zinc oxide. Examples of the coating layer include metal oxides such as tin oxide and titanium oxide.

When the metal oxide is used as the conductive particle, a volume average particle diameter is preferably 1 nm or more and 500 nm or less, and more preferably 3 nm or more and 400 nm or less.

Examples of the resin include a polyester resin, a polycarbonate resin, a polyvinyl acetal resin, an acrylic resin, a silicone resin, an epoxy resin, a melamine resin, polyurethane resin, a phenolic resin and an alkyd resin.

The conductive layer may further contain a masking agent such as silicone oil, a resin particle, or titanium oxide.

The film thickness of the conductive layer is preferably 1 μm or more and 50 μm or less, and particularly preferably 3 μm or more and 40 μm or less.

The conductive layer can be formed by preparing a conductive layer coating liquid containing the above-described materials and a solvent, forming a coating film thereof, and drying the coating film. Examples of the solvent used in the coating liquid include an alcohol solvent, a sulfoxide solvent, a ketone solvent, an ether solvent, an ester solvent and an aromatic hydrocarbon solvent.

Examples of dispersing methods for dispersing the conductive particle in the conductive layer coating liquid include methods using a paint shaker, a sand mill, a ball mill and a liquid collision-type high-speed disperser.

### <Undercoat Layer>

In the electrophotographic photosensitive member used in the present invention, an undercoat layer may be provided on the support or the conductive layer.

The undercoat layer preferably contains a resin. The undercoat layer may also be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenolic resin, a polyvinyl phenolic resin, an alkyd resin, a polyvinyl alcohol resin, a polyethylene oxide resin, a polypropylene oxide resin, a polyamide resin, a polyamide acid resin, a polyimide resin, a polyamideimide resin and a cellulose resin.

Examples of the polymerizable functional group in the monomer having a polymerizable functional group include an isocyanate group, a block isocyanate group, a methylol group, an alkylated methylol group, an epoxy group, a metal alkoxide group, a hydroxy group, an amino group, a carboxy group, a thiol group, a carboxylic anhydride group and a carbon-carbon double bond group.

The undercoat layer may further contain an electron transport material, a metal oxide, a metal, a conductive polymer, or etc. to enhance electrical characteristics. Among them, an electron transport material or a metal oxide is preferably used.

Examples of the electron transport material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound and a boron-containing compound. The undercoat layer may also be formed as a cured film by using an electron transport material having a polymerizable functional group as an electron transport material, and copolymerizing the electron transport material with a monomer having the above-described polymerizable functional group.

Examples of the metal oxide include indium tin oxide, tin oxide, indium oxide, titanium oxide, zinc oxide, aluminum oxide and silicon dioxide. Examples of the metal include gold, silver and aluminum.

The undercoat layer may further contain an additive.

The film thickness of the undercoat layer is preferably 0.1 μm or more and 50 μm or less, more preferably 0.2 μm or more and 40 μm or less, and particularly preferably 0.3 μm or more and 30 μm or less.

The undercoat layer can be formed by preparing an undercoat layer coating liquid containing the above-described materials and a solvent, forming a coating film thereof, and drying and/or curing the coating film. Examples of the solvent used in the coating liquid include an alcohol solvent, a ketone solvent, an ether solvent, an ester solvent and an aromatic hydrocarbon solvent.

### <Photosensitive Layer>

The photosensitive layer of the electrophotographic photosensitive member according to the present invention is mainly classified to (1) a multilayered photosensitive layer and (2) a single-layered photosensitive layer. (1) The multilayered photosensitive layer has a charge generation layer containing a charge generation material, and a charge transport layer having a charge transport material. (2) The single-layered photosensitive layer has a photosensitive layer containing both a charge generation material and a charge transport material.

### (1) Multilayered Photosensitive Layer

The multilayered photosensitive layer has a charge generation layer and a charge transport layer.

### (1-1) Charge Generation Layer

The charge generation layer preferably contains a charge generation material and a resin.

Examples of the charge generation material include an azo pigment, a perylene pigment, a polycyclic quinone pigment, an indigo pigment and a phthalocyanine pigment. Among them, an azo pigment or a phthalocyanine pigment is preferable. Among phthalocyanine pigments, an oxytitanium phthalocyanine pigment, a chlorogallium phthalocyanine pigment, or a hydroxygallium phthalocyanine pigment is preferable.

A content of the charge generation material in the charge generation layer is preferably 40% by mass or more and 85% by mass or less, and more preferably 60% by mass or more 80% by mass or less based on a total mass of the charge generation layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenolic resin, a polyvinyl alcohol resin, a cellulose resin, a polystyrene resin, a polyvinyl acetate resin and a polyvinyl chloride resin. Among them, a polyvinyl butyral resin is more preferable.

The charge generation layer may further contain an additive such as an antioxidant or an ultraviolet absorber. Specific examples thereof include a hindered phenolic compound, a hindered amine compound, a sulfur compound, a phosphorus compound and a benzophenone compound.

The film thickness of the charge generation layer is preferably 0.1 μm or more and 1 μm or less, and more preferably 0.15 μm or more and 0.4 μm or less.

The charge generation layer can be formed by preparing a charge generation layer coating liquid containing the above-described materials and a solvent, forming a coating film thereof, and drying the coating film. Examples of the solvent used in the coating liquid include an alcohol solvent, a sulfoxide solvent, a ketone solvent, an ether solvent, an ester solvent and an aromatic hydrocarbon solvent.

### (1-2) Charge Transport Layer

The charge transport layer preferably contains a charge transport material and a resin.

Examples of the charge transport material include a polycyclic aromatic compound, a heterocyclic compound, a hydrazone compound, a styryl compound, an enamine compound, a benzidine compound, a triarylamine compound, and a resin having a group derived from any of these materials. Among them, a triarylamine compound or a benzidine compound is preferable.

As preferred examples of the charge transport material, structures of CTM1 to CTM10 are shown below.

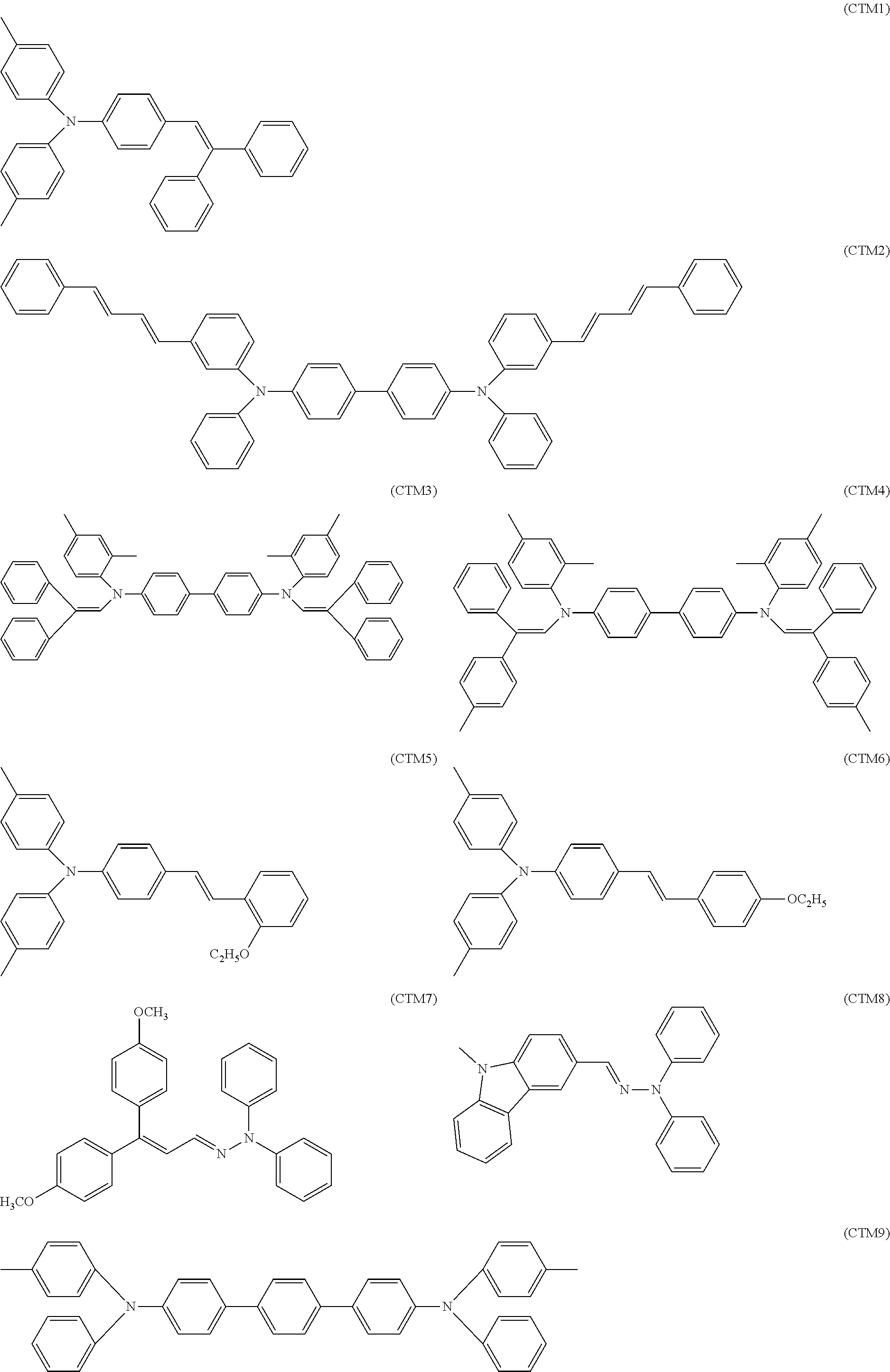

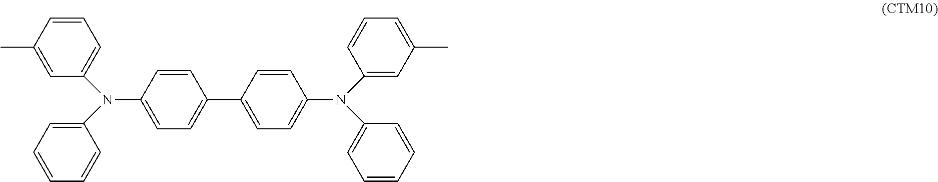

A content of the charge transport material in the charge transport layer is preferably 25% by mass or more and 70% by mass or less, more preferably 30% by mass or more and 55% by mass or less based on the total mass of the charge transport layer.

Examples of the resin include a polyester resin, a polycarbonate resin, an acrylic resin and a polystyrene resin. Among them, a polycarbonate resin, a polyester resin, or an acrylic resin is preferable. As the polyester resin, in particular, a polyarylate resin is preferable.

The content ratio (mass ratio) of the charge transport material and the resin is preferably 4:10 to 20:10, and more preferably 5:10 to 12:10.

The charge transport layer may further contain an additive such as an antioxidant, an ultraviolet absorber, a plasticizer, a leveling agent, a slip agent, or an abrasion resistance improver. Specific examples thereof include a hindered phenol compound, a hindered amine compound, a sulfur compound, a phosphorus compound, a benzophenone compound, a siloxane modified resin, a silicone oil, a fluorine resin particle, a polystyrene resin particle, a polyethylene resin particle, a silica particle, an alumina particle and a boron nitride particle.

The film thickness of the charge transport layer is preferably 5 μm or more and 50 μm or less, more preferably 8 μm or more and 40 μm or less, and particularly preferably 10 μm or more and 30 μm or less.

The charge transport layer can be formed by preparing a charge transport layer coating liquid containing the above-described materials and a solvent, forming a coating film thereof, and drying the coating film. Examples of the solvent used in the coating liquid include an alcohol solvent, a ketone solvent, an ether solvent, an ester solvent and an aromatic hydrocarbon solvent. Among these solvents, an ether solvent or an aromatic hydrocarbon solvent is preferable.

When the charge transport layer is used as the surface layer, the charge transport layer contains a polyester-modified polydimethylsiloxane, and oleamide, as described in the item of <Surface layer> as described above.

### (2) Single-Layered Photosensitive Layer

The single-layered photosensitive layer can be formed by preparing a photosensitive layer coating liquid containing a charge generation material, a charge transport material, a resin and a solvent, forming a coating film thereof on a support, a conductive layer, or an undercoat layer, and drying the coating film. The charge generation material, the charge transport material, and the resin are same as the materials exemplified in the above “(1) Multilayered photosensitive layer”.

### <Overcoat Layer>

In the electrophotographic photosensitive member according to the present invention, an overcoat layer may be provided on the photosensitive layer. By providing the overcoat layer, durability can be improved.

For example, the overcoat layer may be a layer containing a resin and having high strength as long as it is provided to impart durability for achieving long lifetime, and it is not necessarily to enhance the charge transport performance by adding a conductive particle or a charge transport material. However, from a viewpoint of enhancing the basic electrical characteristics of the electrophotographic photosensitive member, it is preferable to add a conductive particle and/or a charge transport material and a resin to achieve both durability and basic electrical characteristics.

It is preferable that the above metal oxide particle has a low volume resistivity and be likely to exert an effect as a charge control agent to the toner. From the above viewpoint, the above metal oxide particle preferably contains at least one metal oxide particle selected from the group consisting of an indium tin oxide particle, a tin oxide particle, a titanium oxide particle, a zinc oxide particle and an aluminum oxide particle. In particular, an indium tin oxide is preferable.

Examples of the charge transport material include a polycyclic aromatic compound, a heterocyclic compound, a hydrazone compound, a styryl compound, an enamine compound, a benzidine compound, a triarylamine compound, and a resin having a group derived from any of these materials. Among them, a triarylamine compound or a benzidine compound is preferable.

The overcoat layer preferably contains no organic compound having a charge transport function, from a viewpoint of costs. In this case, the above metal oxide particle is preferably contained in an overcoat layer, and has the charge transport function to a certain extent. When the overcoat layer contains no organic compound having the charge transport function, the film thickness of the overcoat layer is preferably 0.5 μm or more and 10 μm or less.

With a film thickness of the overcoat layer of less than 0.5 μm, a part not covered with the overcoat layer is highly likely present and the function as the overcoat layer may not be exerted. On the other hand, with a film thickness of the overcoat layer of less than 10 μm, when the electrophotographic photosensitive member is charged in the electrophotographic process, the overcoat layer retains a high distributed voltage due to having no organic compound having a charge transport function. As a result, the residual potential may significantly increase and basic electrical characteristics may be deteriorated.

When the overcoat layer has the charge transport material, the film thickness of the overcoat layer is preferably 0.5 μm or more and 20 μm or less, and more preferably 1 μm or more and 14 μm or less.

Examples of the resin of the overcoat layer include a polyester resin, an acrylic resin, a phenoxy resin, a polycarbonate resin, a polystyrene resin, a phenolic resin, a melamine resin and an epoxy resin. Among them, a polycarbonate resin, a polyester resin, or an acrylic resin is preferable. In addition, in the electrophotographic photosensitive member of the present invention, the polydimethylsiloxane having a polyester chain is preferably a part of the polymer film of the overcoat layer.

The overcoat layer is more preferably formed as a cured film by polymerizing a composition containing a monomer having a polymerizable functional group. Examples of the reaction thereof include a thermal polymerization reaction, a photopolymerization reaction and a radiation polymerization reaction. Examples of the polymerizable functional group in the monomer having a polymerizable functional group include an acryloyl group and a methacryloyl group. As the monomer having a polymerizable functional group, a material having charge transport properties may be used.

As the monomer having a polymerizable functional group, a (meth)acrylic compound is preferable. Examples of the reaction therefor include a thermal polymerization reaction, a photopolymerization reaction and a radiation polymerization reaction. In the electrophotographic photosensitive member of the present invention, the overcoat layer is preferably a polymer film of a composition containing at least one (meth)acrylic compound selected from the group consisting of a (meth)acrylic monomer and a (meth)acrylic oligomer.

The overcoat layer is more preferably a polymer film of a composition containing at least one (meth)acrylic compound selected from the group consisting of (meth)acrylic monomers. Further, in the electrophotographic photosensitive member of the present invention, the composition including the (meth)acrylic compound preferably contains a hexafunctional urethane acrylic monomer or/and a hexafunctional urethane acrylic oligomer.

Accordingly, the electrophotographic photosensitive member of the present invention can suppress the occurrence of image blurring also in a high-temperature and high-humidity environment, while maintaining high cleanability also in a high-speed electrophotographic apparatus.

As preferred examples of the (meth)acrylic monomer, structures represented by the following formulas (ACM1) to (ACM56) are shown below.

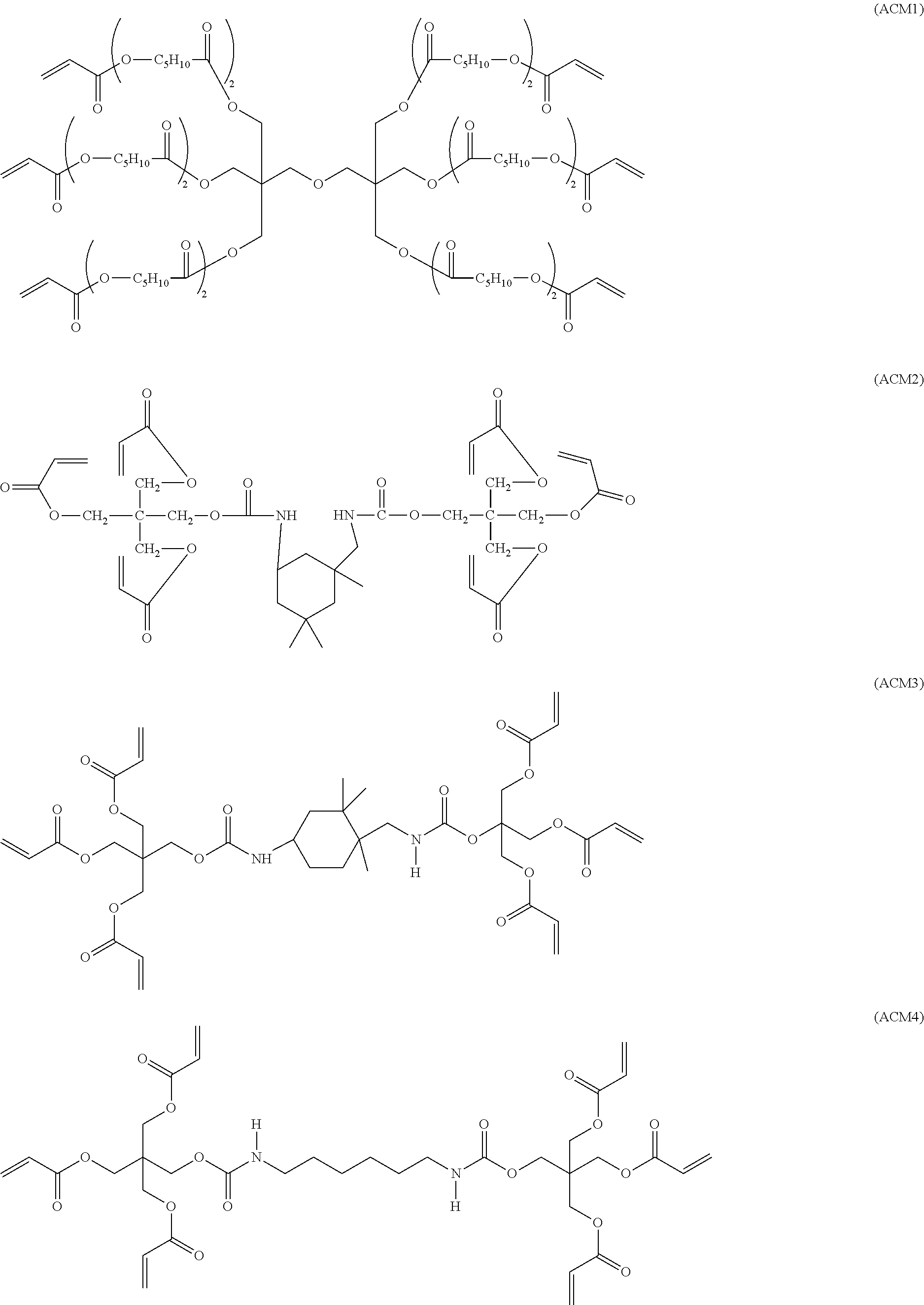

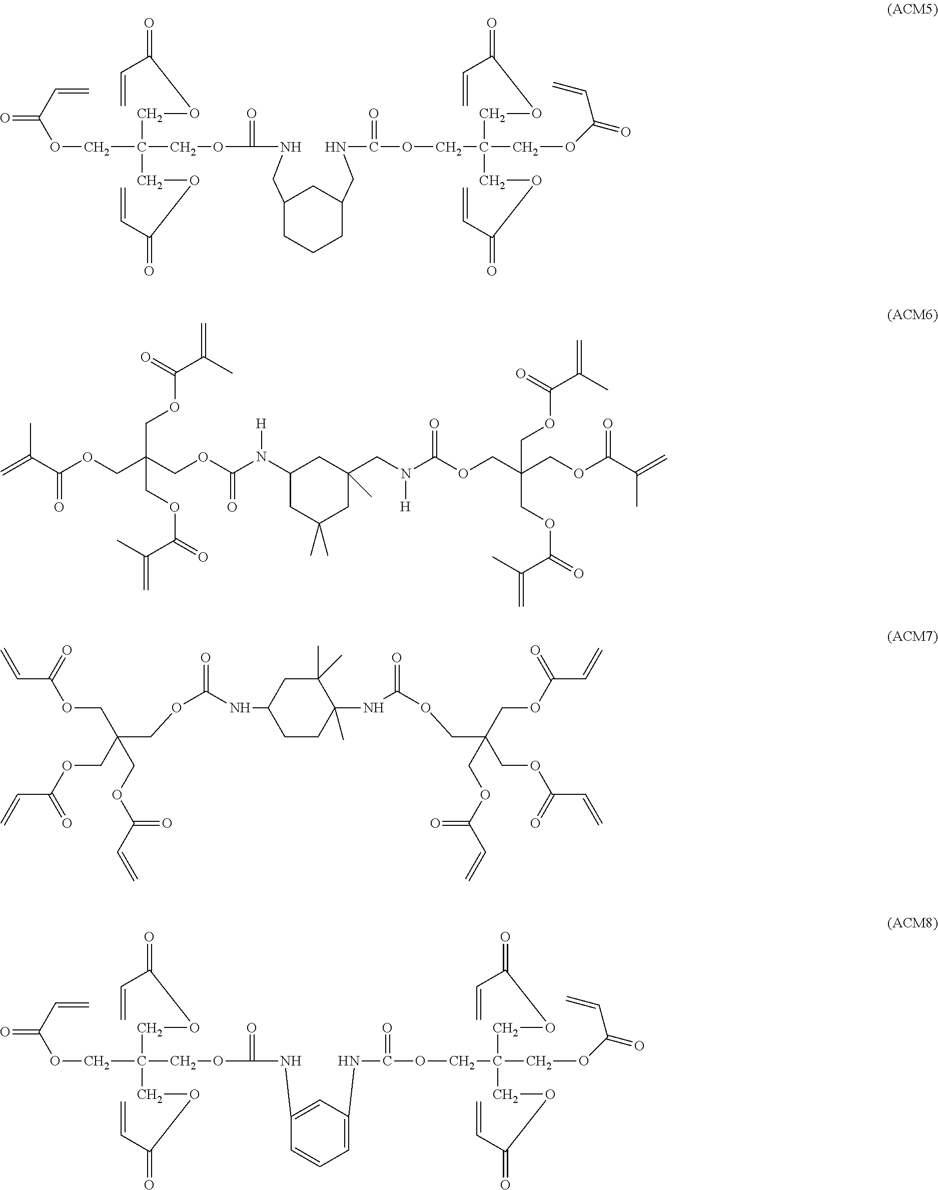

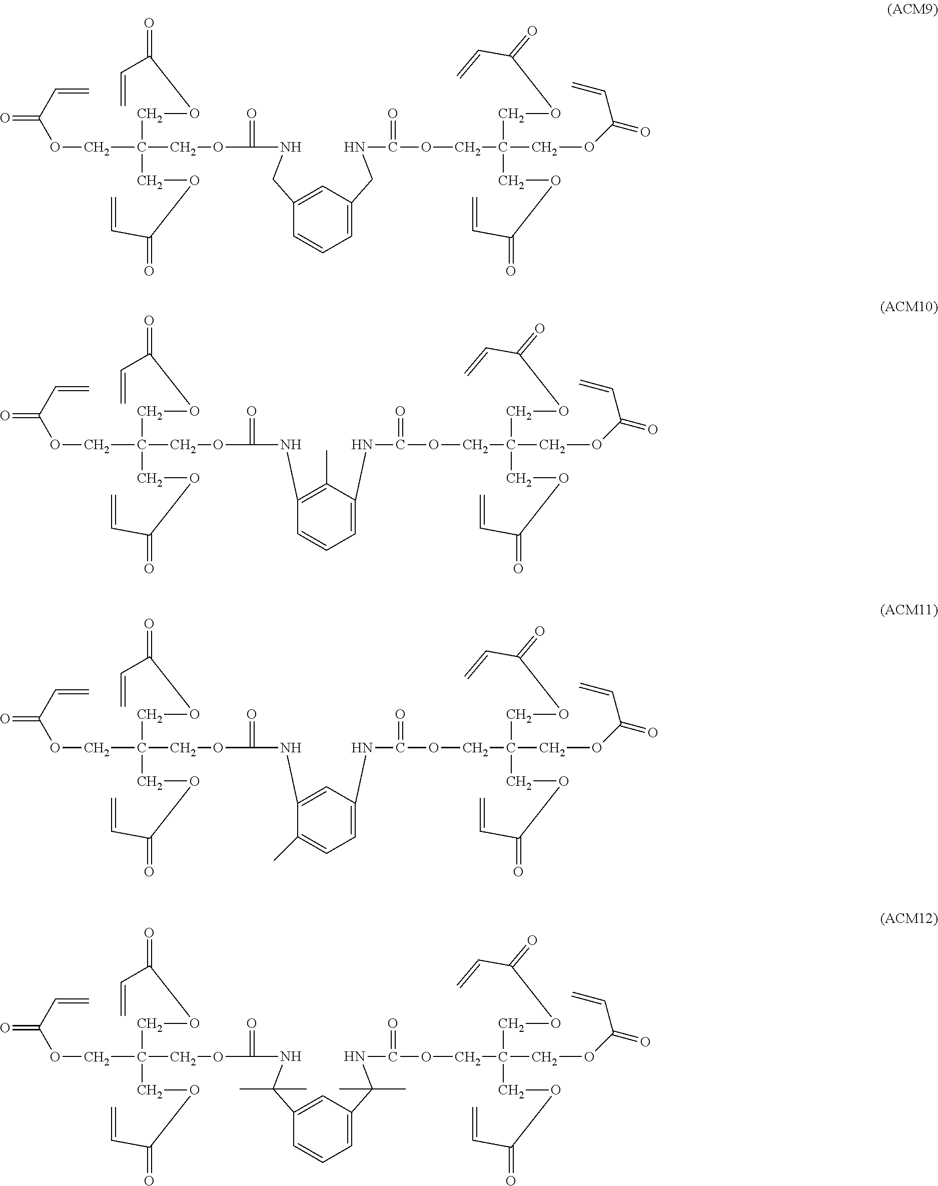 [SMILES: C=CC(=O)OCC(COC(=O)C=C)(COC(=O)C=C)COC(=O)NCc1cccc(CNC(=O)OCC(COC(=O)C=C)(COC(=O)C=C)COC(=O)C=C)c1 ; C=CC(=O)OCC(COC(=O)C=C)(COC(=O)C=C)COC(=O)Nc1cccc(NC(=O)OCC(COC(=O)C=C)(COC(=O)C=C)COC(=O)C=C)c1C ; C=CC(=O)OCC(COC(=O)C=C)(COC(=O)C=C)COC(=O)Nc1ccc(C)c(NC(=O)OCC(COC(=O)C=C)(COC(=O)C=C)COC(=O)C=C)c1 ; C=CC(=O)OCC(COC(=O)C=C)(COC(=O)C=C)COC(=O)NC(C)(C)c1cccc(C(C)(C)NC(=O)OCC(COC(=O)C=C)(COC(=O)C=C)COC(=O)C=C)c1]

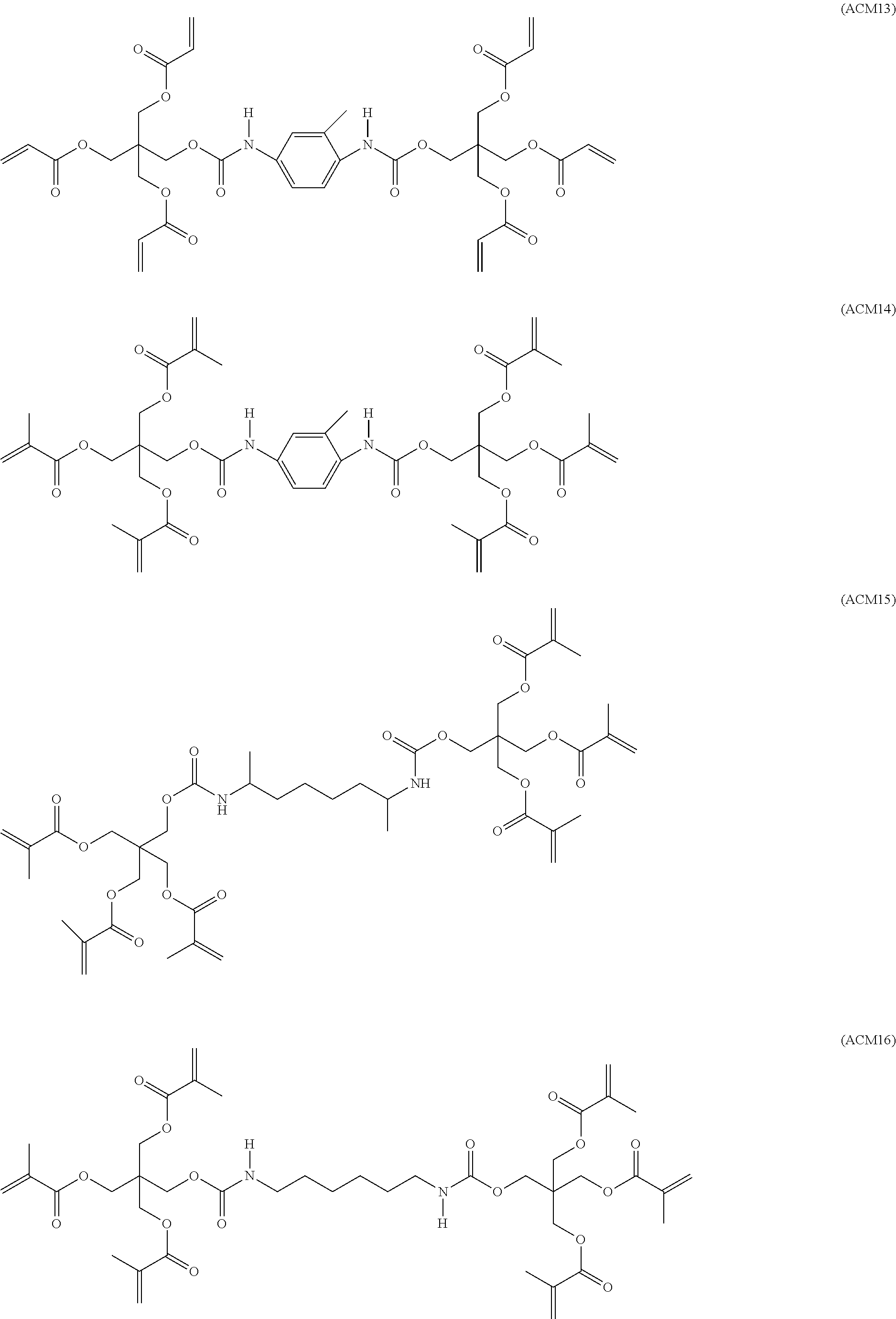

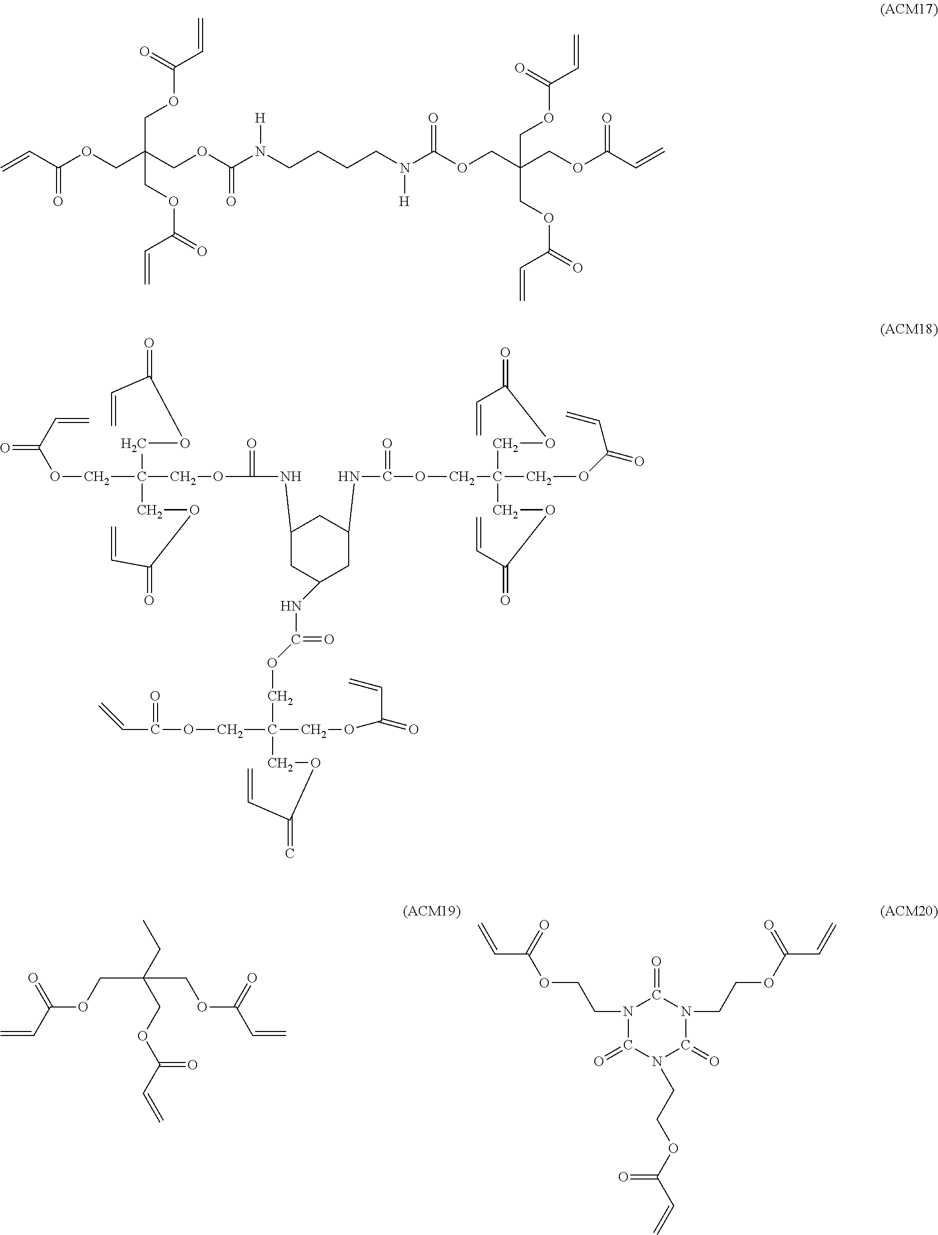

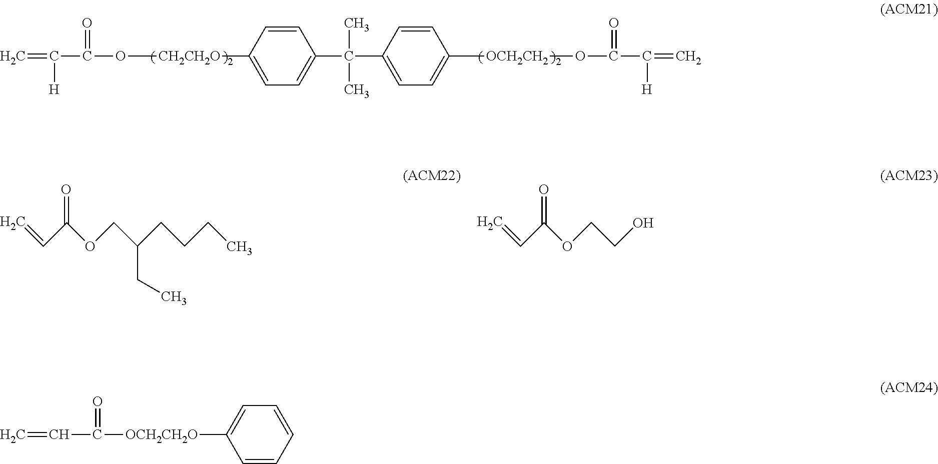

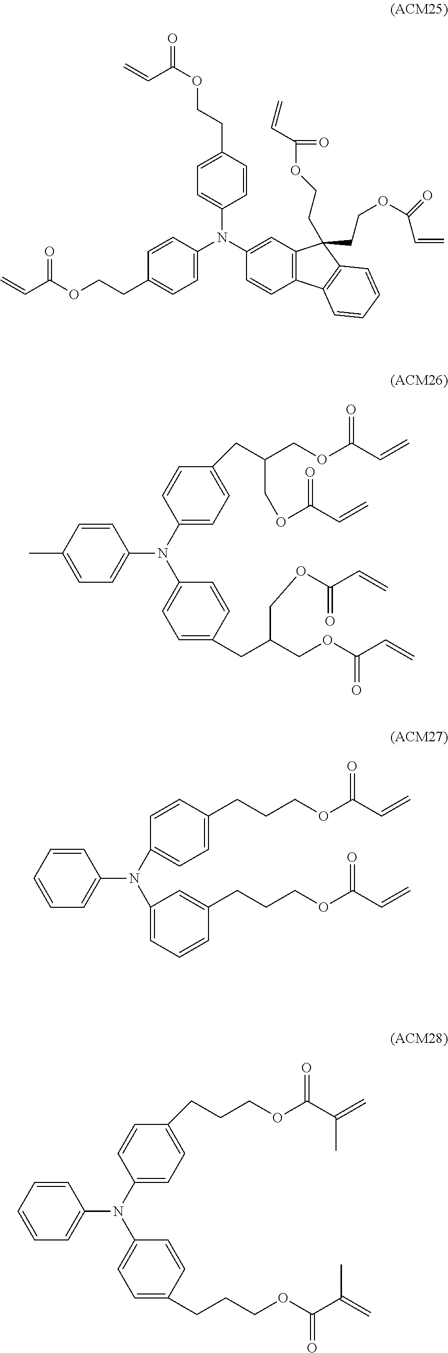

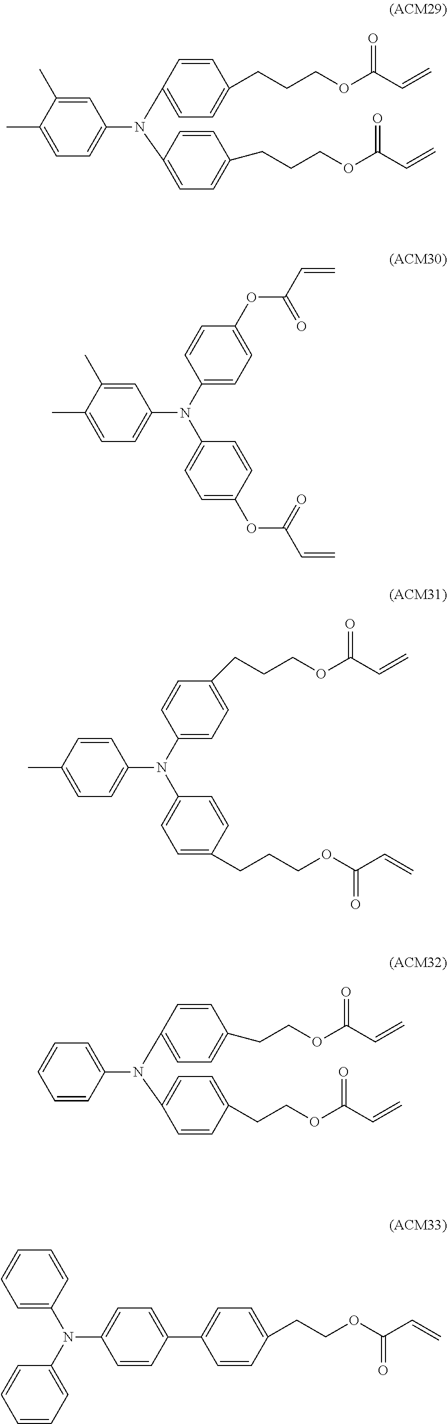

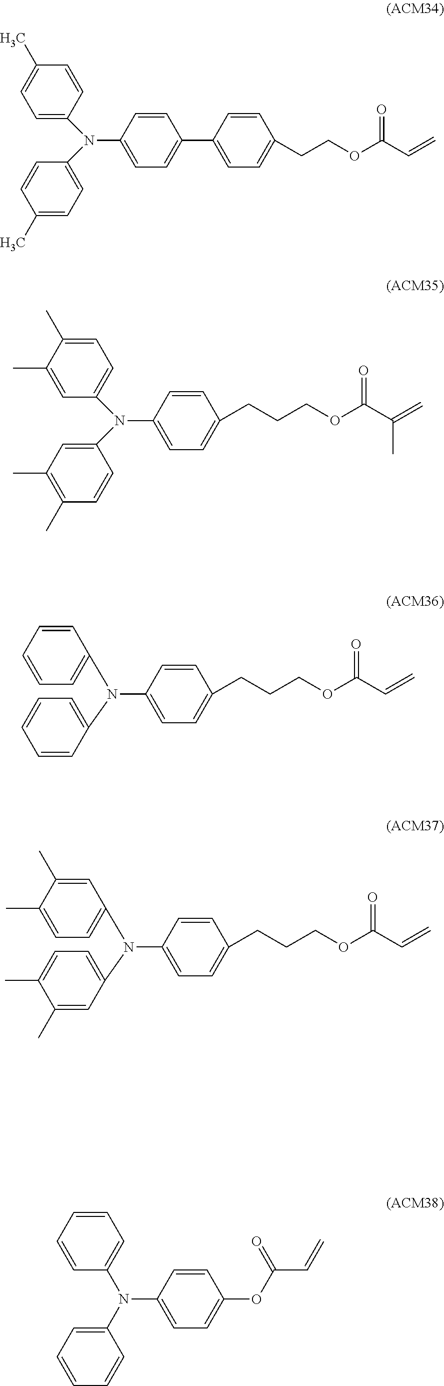

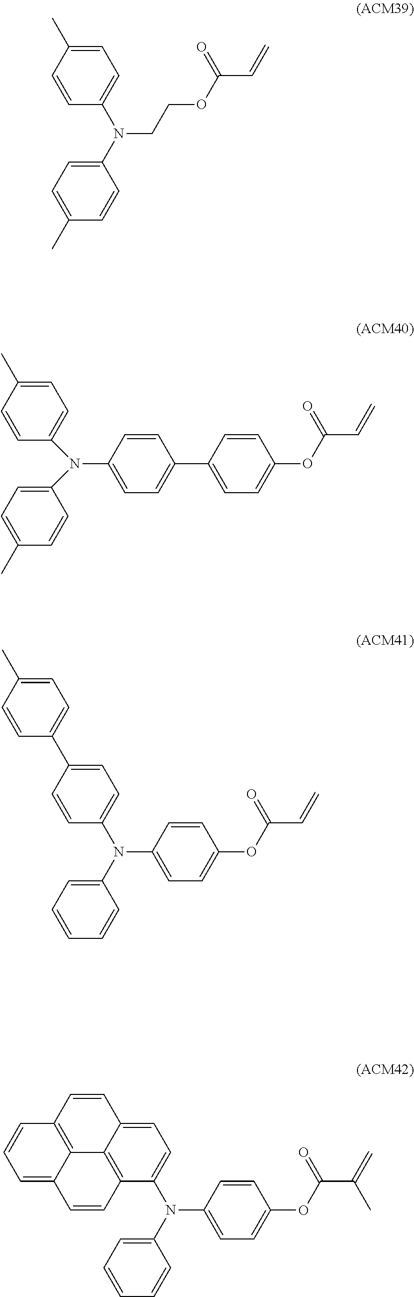 [SMILES: C=CC(=O)OCCN(c1ccc(C)cc1)c1ccc(C)cc1 ; C=CC(=O)Oc1ccc(-c2ccc(N(c3ccc(C)cc3)c3ccc(C)cc3)cc2)cc1 ; C=CC(=O)Oc1ccc(N(c2ccccc2)c2ccc(-c3ccc(C)cc3)cc2)cc1 ; C=C(C)C(=O)Oc1ccc(N(c2ccccc2)c2ccc3ccc4cccc5ccc2c3c45)cc1]

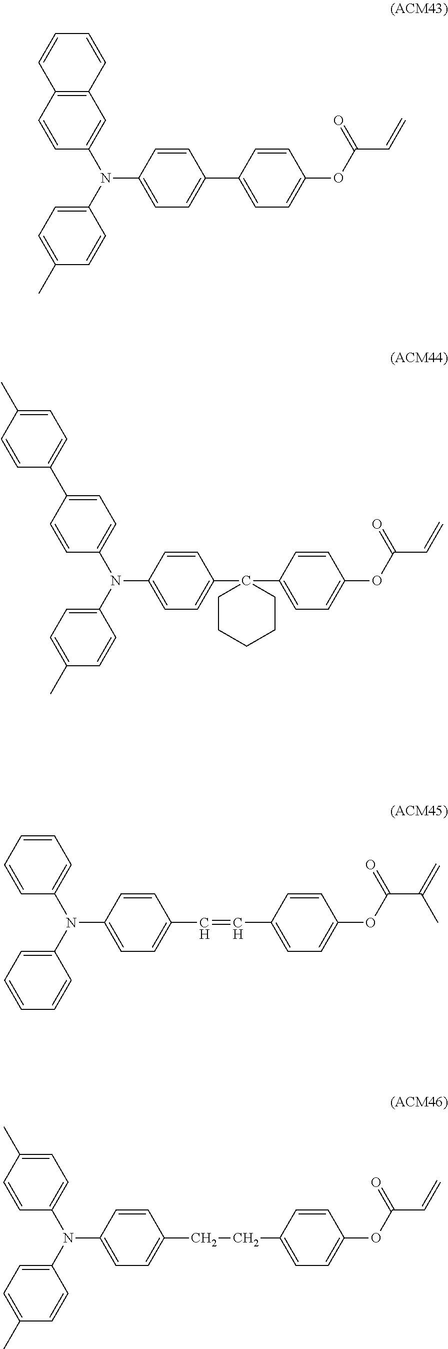 [SMILES: C=CC(=O)Oc1ccc(-c2ccc(N(c3ccc(C)cc3)c3ccc4ccccc4c3)cc2)cc1 ; C=CC(=O)Oc1ccc(C2(c3ccc(N(c4ccc(C)cc4)c4ccc(-c5ccc(C)cc5)cc4)cc3)CCCCC2)cc1 ; C=C(C)C(=O)Oc1ccc(C=Cc2ccc(N(c3ccccc3)c3ccccc3)cc2)cc1 ; C=CC(=O)Oc1ccc(CCc2ccc(N(c3ccc(C)cc3)c3ccc(C)cc3)cc2)cc1]

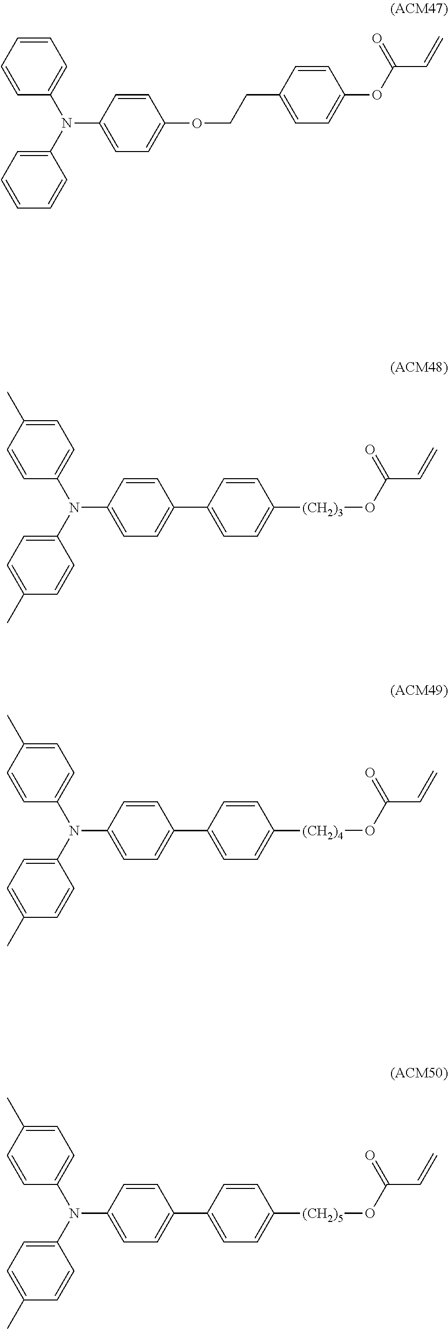

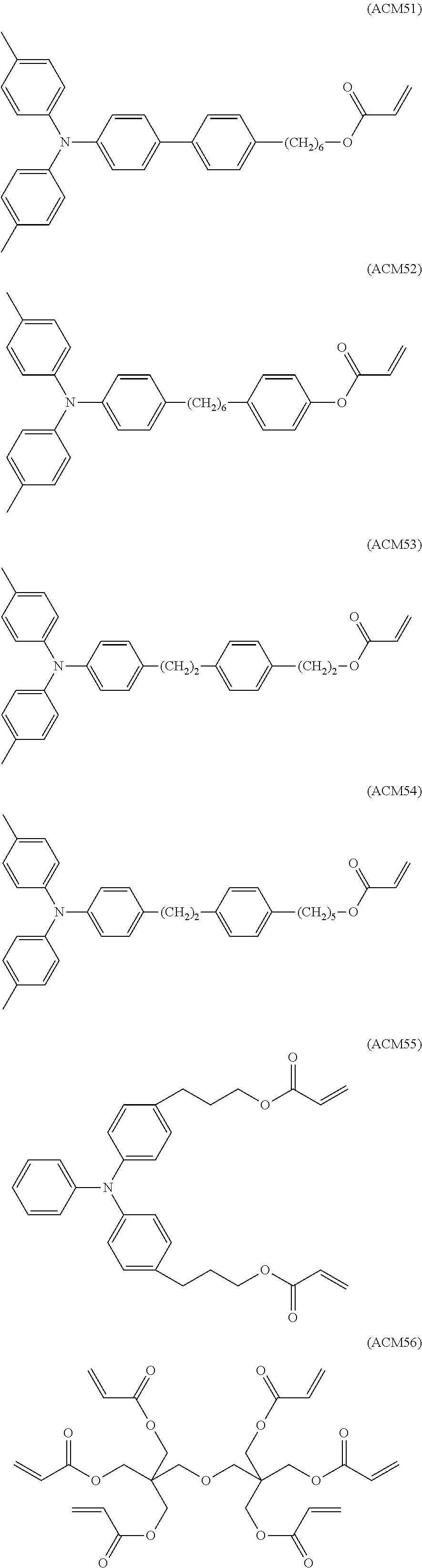

The overcoat layer may further contain an additive such as an antioxidant, an ultraviolet absorber, a plasticizer, a leveling agent, a slip agent, or an abrasion resistance improver. Specific examples of the additive include a hindered phenol compound, a hindered amine compound, a sulfur compound, a phosphorus compound, a benzophenone compound, a siloxane modified resin, a silicone oil, a fluorine resin particle, a polystyrene resin particle, a polyethylene resin particle, a silica particle, an alumina particle and a boron nitride particle.

The overcoat layer can be formed by preparing an overcoat layer coating liquid containing the above-described materials and a solvent, forming a coating film, and drying and/or curing the coating film. Examples of the solvent used in the coating liquid include an alcohol solvent, a ketone solvent, an ether solvent, a sulfoxide solvent, an ester solvent and an aromatic hydrocarbon solvent.

### Second Embodiment

The second embodiment relates to a method for producing an electrophotographic photosensitive member. The method for producing an electrophotographic photosensitive member of the present invention is a method for producing an electrophotographic photosensitive member having a surface layer, the method including: a preparation step of preparing a coating liquid for the surface layer, an application step of applying the coating liquid, and a solidification step of drying or curing the applied coating liquid, wherein the coating liquid contains a polydimethylsiloxane having a polyester chain, and oleamide. Hereinafter, each step for producing the surface layer will be described. Since the method for producing an electrophotographic photosensitive member excluding the surface layer and each material (e.g., the coating liquid) are as described above or known methods can be used therefor, the description is omitted.

### (Preparation Step)

The electrophotographic photosensitive member of the present invention includes a preparation step of preparing a coating liquid for a surface layer. The method for preparing the coating liquid for the surface layer of the present invention may be a method that enables uniform mixing of the coating liquid. Examples thereof include a ball mill, a bead mill, stirring, ultrasonic wave, heating and rotary stirring (a roll stand), and a method combining these available methods can be used.

### (Application Step)

The electrophotographic photosensitive member of the present invention includes an application step of applying the coating liquid. Examples of the method for applying the coating liquid of the present invention include dip coating, spray coating, inkjet coating, roll coating, die coating, blade coating, curtain coating, wire bar coating and ring coating. Among them, dip coating is preferable from the viewpoint of efficiency and productivity.

### (Solidification Step)

The electrophotographic photosensitive member of the present invention includes a solidification step of drying or curing the applied coating liquid. As the method for solidifying the surface layer of the present invention, for example, a drying step, a curing step, or a method combining these steps can be used.

### (Drying Step)

Examples of the method for drying the applied coating liquid of the present invention include heat drying, blast drying and vacuum drying, and a method combining these available methods can be used. In particular, heat drying and heating and blast drying are preferable, from a viewpoint of productivity. To rapidly dry a cylindrical support surface, a drying furnace, a drying machine, or an inside of a drying chamber is preferably set to the desired temperature before the drying step.

The drying temperature in the drying step is preferably 100° C. or more and 150° C. or less. The drying time in the drying step is preferably 20 minutes or more and 120 minutes or less, and further preferably 40 minutes or more and 100 minutes or less.

### (Curing Step)

Examples of the method for curing the applied coating liquid of the present invention include UV curing, thermal curing and EB curing, and a method combining these available methods can be used. In particular, EB curing is preferable from a viewpoint of the wear resistance of the electrophotographic photosensitive member.

### Application Example

Application examples of the present invention are a process cartridge and an electrophotographic apparatus.

The process cartridge of the present invention integrally supports the above electrophotographic photosensitive member and at least one unit selected from the group consisting of a charging unit, a developing unit and a cleaning unit, and is detachable from the body of an electrophotographic apparatus.

The electrophotographic apparatus of the present invention has the above electrophotographic photosensitive member, a charging unit, an exposure unit, a developing unit and a transfer unit.

### [Process Cartridge, Electrophotographic Apparatus]

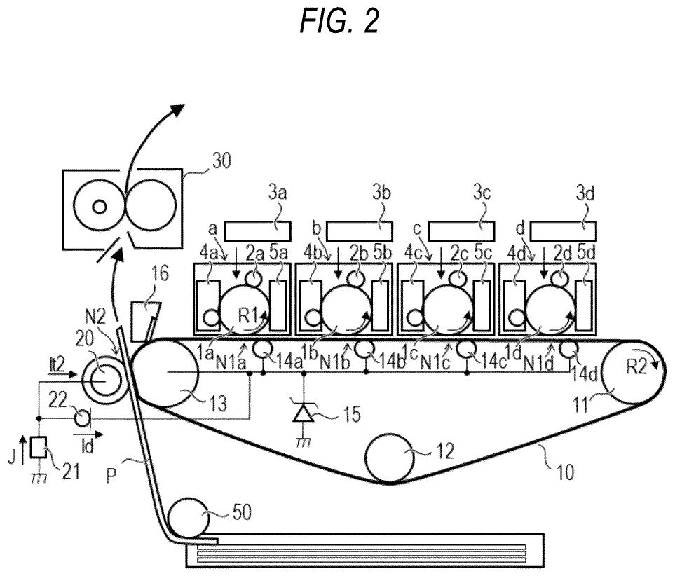

FIG. 2 illustrates an example of schematic configuration of the electrophotographic apparatus having the process cartridge including the electrophotographic photosensitive member of the present invention.

The electrophotographic apparatus of the present example is a so-called tandem type electrophotographic apparatus in which a plurality of image forming parts a to d are provided. The first image forming part a, the second image forming part b, the third image forming part c and the fourth image forming part d respectively form images by yellow (Y), magenta (M), cyan(C) and black (Bk) toners.

These four image forming parts are arranged in a line at a certain interval, and in the structure of each image forming part, there are many parts substantially common to each other, except for the toner color to be accommodated. Therefore, the electrophotographic apparatus of the present example will be described below using first image forming part a.

The first image forming part a has a photosensitive drum 1a as a drum-shaped electrophotographic photosensitive member, a charging roller 2a as a charging member, a developing unit 4a and a drum cleaning unit 5a.

The photosensitive drum 1a is an image carrier that carries a toner image, and is rotationally driven in the direction of an arrow R1 in the drawing at a predetermined circumferential speed (process speed). The developing unit 4a stores yellow toner and develops yellow toner on the photosensitive drum 1a.

The drum cleaning unit 5a is a unit for recovering the toner attached to the photosensitive drum 1a. The drum cleaning unit 5a has a cleaning blade to be brought into contact with the photosensitive drum 1a, and a waste toner box that stores the toner removed from the photosensitive drum 1a by the cleaning blade.

When a control unit such as a controller (not shown) receives an image signal, image forming operation is started, and the photosensitive drum 1a is rotationally driven. The photosensitive drum 1a is uniformly subjected to charging treatment at a predetermined polarity (negative polarity in the present example) to a predetermined voltage (charged voltage) by the charging roller 2a in the rotational process, and is exposed by the exposure unit 3a according to the image signal.

Consequently, an electrostatic latent image corresponding to the yellow component image of an intended color image is formed on the photosensitive drum 1a. Thereafter, the electrostatic latent image is developed at the development position by the developing unit 4a, and visualized as a yellow toner image on the photosensitive drum 1a.

Here, the regular charge polarity of the toner stored in the developing unit 4a is negative polarity, and the electrostatic latent image is reversely developed by the toner charged with the same polarity as the polarity of the photosensitive drum 1a charged by the charging roller 2a. However, the present invention is not limited thereto. The present invention can also be applied to an electrophotographic apparatus in which an electrostatic latent image is positively developed by the toner charged with the polarity opposite to the charge polarity of the photosensitive drum 1a.

An endless movable intermediate transfer belt 10 has conductivity, is brought into contact with the photosensitive drum 1a to form a primary transfer part N1a, and rotates at a circumferential speed substantially equal to the circumferential speed of the photosensitive drum 1a. The intermediate transfer belt 10 is tensioned by a facing roller 13 serving as a facing member, a driving roller 11 and a tension roller 12 serving as tension members, and a metal roller 14a, and is tensioned by the tension roller 12 at a tension of 60 N in total pressure.

The intermediate transfer belt 10 can be moved by the driving roller 11 rotational driven in the direction of an arrow R2 in the drawing. Respective metal rollers 14 and the facing roller 13 are connected to an earth via a zener diode 15 serving as a constant-voltage element.

The yellow toner image formed on the photosensitive drum 1a is primarily transferred from the photosensitive drum 1a to the intermediate transfer belt 10 in a process of passing through the primary transfer part N1a. The primary transfer residual toner remained on the surface of the photosensitive drum 1a is cleaned and removed by the drum cleaning unit 5a, and then subjected to charging and the following image forming processes.

During primary transfer, a current is supplied from the secondary transfer roller 20 serving as a secondary transfer member brought into contact with the outer circumference surface of the intermediate transfer belt 10 to the conductive intermediate transfer belt 10. When the current supplied from the secondary transfer roller 20 flows in the circumferential direction of the intermediate transfer belt 10, the toner image is primarily transferred from the photosensitive drum 1a to the intermediate transfer belt 10. Then, a voltage J that has a predetermined polarity (positive polarity in the present example) opposite to the regular charge polarity of the toner is applied from a transfer power supply 21 to the secondary transfer roller 20.

Note that, in the second, third and fourth image forming parts in FIG. 2, 1b, 1c and 1d each represent a photosensitive drum, 2b, 2c and 2d each represent a charging roller, 3b, 3c and 3d each represent an exposure unit, 4b, 4c and 4d each represent a developing unit, 5b, 5c and 5d each represent a drum cleaning unit, 14b, 14c and 14d each represent a metal roller, and N1b, N1c and N1d each represent a primary transfer part.

A magenta toner image as the second color, a cyan toner image as the third color and a black toner image as the fourth color are formed in the same manner, and are transferred by being sequentially superposed on the intermediate transfer belt 10. Consequently, a four-colored toner image corresponding to an intended color image is formed on the intermediate transfer belt 10.

Then, the four-colored toner image carried on the intermediate transfer belt 10 is secondary transferred to the surface of a transfer material P such as paper or an OHP sheet fed by a paper feeding unit 50 collectively, in a process of passing through a secondary transfer part N2 that is formed by bringing the secondary transfer roller 20 into contact with the intermediate transfer belt 10.

The transfer material P to which the four-colored toner image is transferred by secondary transfer is then heated and pressurized in a fixing unit 30, so that the toners of four colors are melted and mixed, and fixed on the transfer material P. The toner remained on the intermediate transfer belt 10 after secondary transfer is cleaned and removed by a belt cleaning unit 16 provided facing to the facing roller 13 via the intermediate transfer belt 10.

In addition, a route not passing through the secondary transfer roller 20 and electrically connecting the transfer power supply 21 and respective metal rollers 14 via a constant current diode 22 serving as a constant current element is provided. When a voltage is applied from the transfer power supply 21 to the secondary transfer roller 20, a pinch-off current Id flows through the constant current diode 22, separately from a current It2 flowing towards the secondary transfer part N2.

The electrophotographic photosensitive member of the present invention can be used for laser beam printers, LED printers, photocopiers, and the like.

### Examples

Hereinafter, the present invention will be described further in detail by way of Examples and Comparative Examples. The present invention is in no way limited to Examples below without departing from the gist thereof. In the description of Examples below, “parts” is in terms of mass, unless otherwise specified.

The film thickness of each layer of the electrophotographic photosensitive member produced in Examples and Comparative Examples were determined by a method using an eddy current film thickness meter (Fischerscope®, manufactured by FISCHER INSTRUMENTS K.K.) or a method for calculating the mass per unit area in terms of specific gravity, except for the charge generation layer. The film thickness of the charge generation layer was determined as follows.

That is, a Macbeth density value was measured by pressing a spectrodensitometer (trade name: X-Rite504/508, manufactured by X-Rite, Inc.) against the surface of the electrophotographic photosensitive member. Using a calibration curve obtained in advance from the Macbeth concentration value and a measured value of the film thickness obtained by the observation of an SEM image of a cross-section, the film thickness was calculated from the measured Macbeth concentration value.

### <Preparation of Charge Generation Layer Coating Liquid>

### Synthetic Example

5.0 g of o-phthalodinitrile and 2.0 g of titanium(IV) chloride were heated and stirred in 100 g of α-chloronaphthalene at 200° C. for 3 hours, and then cooled to 50° C., and the precipitated crystal was filtered off to obtain a paste of dichlorotitanium phthalocyanine.

The paste was then washed under stirring with 100 mL of N,N-dimethylformamide heated to 100° C., then repeatedly cleaned with 100 mL of methanol at 60° C. twice, and filtered off. Further, the obtained paste was stirred in 100 mL of deionized water at 80° C. for 1 hour and filtered off to obtain 4.3 g of a blue titanyl phthalocyanine pigment.

### Milling Example

0.5 parts of the titanyl phthalocyanine pigment obtained in Synthetic Example, 10 parts of tetrahydrofuran and 15 parts of glass beads having a diameter of 0.9 mm were subjected to milling treatment at a cooling water temperature of 18° C. for 48 hours using a sand mill. The sand mill used here was a sand mill (K-800, manufactured by Igarashi Machine Production Co., Ltd. (currently Aimex Co., Ltd.), disk diameter: 70 mm, number of disks: 5).

Then, milling treatment was carried out under conditions where a disk rotates 500 rotations per 1 minute. The liquid thus treated was filtered through a filter (product number: N-NO. 125T, pore diameter: 133 μm, manufactured by NBC Meshtec Inc.) to remove glass beads. To the resulting liquid, 30 parts of tetrahydrofuran was added, the mixture was then filtered, and the residue on the filter was sufficiently washed with methanol and water.

Then, the washed residue was dried under vacuum to obtain 0.45 parts of the titanyl phthalocyanine pigment. The obtained pigment had a strong peak at a Bragg angle 2θ of 27.2°±0.3° in the X-ray diffraction spectrum using CuKα rays.

The following materials were prepared.
Titanyl phthalocyanine pigment obtained in the milling example: 12 parts
Polyvinyl butyral (trade name: S-LEC BX-1, manufactured by SEKISUI CHEMICAL CO., LTD.): 10 parts
Cyclohexanone: 158 parts
Glass beads having a diameter of 0.9 mm: 402 parts

These were subjected to disperse treatment under a cooling water temperature of 18° C. for 4 hours using a sand mill (K-800, manufactured by Igarashi Machine Production Co., Ltd. (currently Aimex Co., Ltd.), disk diameter: 70 mm, number of disks: 5). In this case, milling treatment was performed under conditions where a disk rotates 1,800 rotations per 1 minute. After glass beads were removed, 369 parts of cyclohexanone and 527 parts of ethyl acetate were added to the dispersion liquid to prepare a charge generation layer coating liquid.

### <Preparation of Charge Transport Layer Coating Liquid>

### [Preparation of Charge Transport Layer Coating Liquid 1]

The following materials were prepared.
CTM9 as the charge transport material: 100 parts
Polycarbonate A resin having a structural unit represented by the following formula (A): 183 parts

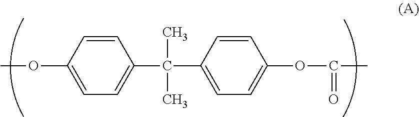

Polycarbonate Z resin having a structural unit represented by the following formula Z): 183 parts

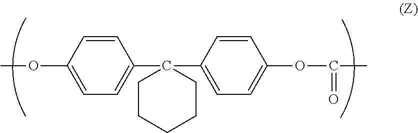

Siloxane resin (trade name: DC200, manufactured by Dow Corning Toray Co., Ltd.): 0.03 parts

These materials were dissolved in a mixed solvent of 1,400 parts of tetrahydrofuran and 600 parts of 1,4-dioxane to prepare the charge transport layer coating liquid 1.

### [Preparation of Charge Transport Layer Coating Liquid 2]

The charge transport layer coating liquid 2 was prepared in a same manner as the charge transport layer coating liquid 1, except that BYK-310 (manufactured by BYK-Chemie): 0.75 parts was added as the polyester-modified polydimethylsiloxane to the charge transport layer coating liquid 1.

### [Preparation of Charge Transport Layer Coating Liquid 3]

The charge transport layer coating liquid 3 was prepared in a same manner as the charge transport layer coating liquid 2, except that oleamide (product code: 00107, manufactured by Tokyo Kasei Kogyo Co., Ltd.): 0.75 parts was added to the charge transport layer coating liquid 2.

### [Preparation of Charge Transport Layer Coating Liquid 4]

The following materials were prepared.
CTM9 as the charge transport material: 100 parts Polycarbonate Z resin having a structural unit represented by the following formula (Z): 366 parts

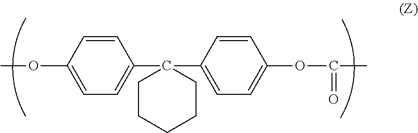

Siloxane resin (trade name: DC200, manufactured by Dow Corning Toray Co., Ltd.): 0.03 parts
BYK-310 (manufactured by BYK-Chemie) as polyester-modified polydimethylsiloxane: 0.75 parts
Oleamide (product code: 00107, manufactured by Tokyo Kasei Kogyo Co., Ltd.): 0.75 parts

These materials were dissolved in a mixed solvent of 1,400 parts of tetrahydrofuran and 600 parts of 1,4-dioxane to prepare a charge transport layer coating liquid 4.

### <Preparation of Overcoat Layer Coating Liquid>

### [Preparation of ITO Dispersion Liquid 1]

ITO particle (product name: E-ITO, manufactured by Mitsubishi Materials Corporation): 29.7 parts
Oleamide (manufactured by Tokyo Kasei Kogyo Co., Ltd.): 0.20 parts
Methyl stearate (manufactured by Tokyo Kasei Kogyo Co., Ltd.): 0.04 parts
Methyl palmitate (manufactured by Tokyo Kasei Kogyo Co., Ltd.): 0.03 parts
Dimethyl glutaconate (manufactured by FUJIFILM Wako Pure Chemical Corporation): 0.03 parts

These materials were dispersed in 2-propanol: 70 parts to prepare the ITO dispersion liquid 1.

### [Preparation of ITO Dispersion Liquid 2]

The ITO dispersion liquid 2 was prepared in a same manner as the ITO dispersion liquid 1, except that oleamide was 0.13 parts and methyl stearate was 0.11 parts in the ITO dispersion liquid.

### [Preparation of ITO Dispersion Liquid 3]

The ITO dispersion liquid 3 was prepared in a same manner as the ITO dispersion liquid 1, except that an amount of oleamide to be added in the ITO dispersion liquid was 0.10 parts and methyl stearate was 0.14 parts.

### [Preparation of ITO Dispersion Liquid 4]

The ITO dispersion liquid 4 was prepared in a same manner as the ITO dispersion liquid 1, except that an amount of oleamide to be added in the ITO dispersion liquid was 0.09 parts and methyl stearate was 0.15 parts.

### [Preparation of ITO Dispersion Liquid 5]

ITO particle (product name: E-ITO, manufactured by Mitsubishi Materials Corporation): 29.7 parts
Methyl stearate (manufactured by Tokyo Kasei Kogyo Co., Ltd.): 0.14 parts
Methyl palmitate (manufactured by Tokyo Kasei Kogyo Co., Ltd.): 0.08 parts
Dimethyl glutaconate (manufactured by FUJIFILM Wako Pure Chemical Corporation): 0.08 parts

These materials were dispersed in 2-propanol: 70 parts to prepare the ITO dispersion liquid 5.

### [Preparation of SnO₂ Dispersion Liquid]

SnO₂ particle (product name: T-1, manufactured by Mitsubishi Materials Corporation): 59.7 parts
Oleamide (manufactured by Tokyo Kasei Kogyo Co., Ltd.): 0.2 parts
Methyl stearate (manufactured by Tokyo Kasei Kogyo Co., Ltd.): 0.04 parts
Methyl palmitate (manufactured by Tokyo Kasei Kogyo Co., Ltd.): 0.03 parts
Dimethyl glutaconate (manufactured by FUJIFILM Wako Pure Chemical Corporation): 0.03 parts

These materials were dispersed in 2-propanol: 140 parts to prepare the SnO₂ dispersion liquid.

### [TiO₂ Dispersion Liquid]

TiO₂ particle (rutile type titanium oxide particle (average primary particle diameter: 50 nm), manufactured by TAYCA CORPORATION): 89.7 parts
Oleamide (manufactured by Tokyo Kasei Kogyo Co., Ltd.): 0.2 parts
Methyl stearate (manufactured by Tokyo Kasei Kogyo Co., Ltd.): 0.04 parts
Methyl palmitate (manufactured by Tokyo Kasei Kogyo Co., Ltd.): 0.03 parts
Dimethyl glutaconate (manufactured by FUJIFILM Wako Pure Chemical Corporation): 0.03 parts

These materials were dispersed in 2-propanol: 210 parts to prepare the TiO₂ dispersion liquid.

### [Preparation of Overcoat Layer Coating Liquid 1]

The following materials were prepared.
ACM2 as the (meth)acrylic compound (Ebecryl E8301, manufactured by DAICEL-ALLNEX LTD.): 100 parts
ITO dispersion liquid 1: 38 parts
Cross-linkable polyester-modified polydimethylsiloxane having an acryloyl group (BYK-UV3570, manufactured by BYK-Chemie): 0.71 parts
Oleamide (manufactured by Tokyo Kasei Kogyo Co., Ltd.) 0.64 parts

These materials were dissolved in ethanol: 420 parts to prepare the overcoat layer coating liquid 1.

### [Preparation of Overcoat Layer Coating Liquids 2 to 34]

Overcoat layer coating liquids 2 to 34 were prepared in a same manner as the preparation of the overcoat layer coating liquid 1, except that, in the preparation of the overcoat layer coating liquid 1, the type and ratio of the materials to be formulated were changed or added as shown in Table 1.

### [Preparation of Overcoat Layer Coating Liquid 35]

Phenolic resin as the binder material (monomer/oligomer of phenolic resin) (trade name: Plyophen J-325, manufactured by DIC Corporation, resin solid: 60%): 166.67 parts
ITO dispersion liquid 1:38 parts
Polyester-modified polydimethylsiloxane (BYK-310, manufactured by BYK-Chemie): 0.71 parts
Oleamide (manufactured by Tokyo Kasei Kogyo Co., Ltd.): 0.64 parts

These materials were dissolved in 1-methoxy 2-propanol: 353.33 parts to prepare the overcoat layer coating liquid.

TABLE 1

| | | | | Amount | Metal oxide | |
|---|---|---|---|---|---|---|
| | | | | of | particle | |
| | | Polydimethylsiloxane | | oleamide | dispersion liquid | |
| Overcoat | | | Amount | to be | | Amount |
| layer | | | (parts | added | | (parts |
| coating | | | by | (parts by | | by |
| liquid No | Binder resin | Type | mass) | mass) | Type | mass) |
| Overcoat | ACM2 | BYK-UV3570 | 0.71 | 0.64 | ITO | 38 |
| layer | | | | | dispersion | |
| coating | | | | | liquid 1 | |
| liquid 1 | | | | | | |
| Overcoat | ACM2 | BYK-UV3570 | 0.71 | 0.23 | ITO | 38 |
| layer | | | | | dispersion | |
| coating | | | | | liquid 1 | |
| liquid 2 | | | | | | |
| Overcoat | ACM2 | BYK-UV3570 | 0.72 | 1.04 | ITO | 38 |
| layer | | | | | dispersion | |
| coating | | | | | liquid 1 | |
| liquid 3 | | | | | | |
| Overcoat | ACM2 | BYK-UV3570 | 0.11 | 0.00 | ITO | 38 |
| layer | | | | | dispersion | |
| coating | | | | | liquid 4 | |
| liquid 4 | | | | | | |
| Overcoat | ACM2 | BYK-UV3570 | 0.11 | 0.10 | ITO | 38 |
| layer | | | | | dispersion | |
| coating | | | | | liquid 1 | |
| liquid 5 | | | | | | |
| Overcoat | ACM2 | BYK-UV3570 | 0.17 | 0.00 | ITO | 38 |
| layer | | | | | dispersion | |
| coating | | | | | liquid 2 | |
| liquid 6 | | | | | | |
| Overcoat | ACM2 | BYK-UV3570 | 0.17 | 0.00 | ITO | 38 |
| layer | | | | | dispersion | |
| coating | | | | | liquid 1 | |
| liquid 7 | | | | | | |
| Overcoat | ACM2 | BYK-UV3570 | 0.17 | 0.10 | ITO | 38 |
| layer | | | | | dispersion | |
| coating | | | | | liquid 1 | |
| liquid 8 | | | | | | |
| Overcoat | ACM2 | BYK-UV3570 | 0.17 | 0.19 | ITO | 38 |
| layer | | | | | dispersion | |
| coating | | | | | liquid 1 | |
| liquid 9 | | | | | | |
| Overcoat | ACM2 | BYK-UV3570 | 0.17 | 0.23 | ITO | 38 |
| layer | | | | | dispersion | |
| coating | | | | | liquid 1 | |
| liquid 10 | | | | | | |
| Overcoat | ACM2 | BYK-UV3570 | 0.23 | 0.00 | ITO | 38 |
| layer | | | | | dispersion | |
| coating | | | | | liquid 1 | |
| liquid 11 | | | | | | |
| Overcoat | ACM2 | BYK-UV3570 | 0.23 | 0.28 | ITO | 38 |
| layer | | | | | dispersion | |
| coating | | | | | liquid 1 | |
| liquid 12 | | | | | | |
| Overcoat | ACM2 | BYK-UV3570 | 1.29 | 0.32 | ITO | 38 |
| layer | | | | | dispersion | |
| coating | | | | | liquid 1 | |
| liquid 13 | | | | | | |
| Overcoat | ACM2 | BYK-UV3570 | 1.29 | 0.46 | ITO | 38 |
| layer | | | | | dispersion | |
| coating | | | | | liquid 1 | |
| liquid 14 | | | | | | |
| Overcoat | ACM2 | BYK-UV3570 | 1.29 | 1.21 | ITO | 38 |
| layer | | | | | dispersion | |
| coating | | | | | liquid 1 | |
| liquid 15 | | | | | | |
| Overcoat | ACM2 | BYK-UV3570 | 1.30 | 1.94 | ITO | 38 |
| layer | | | | | dispersion | |
| coating | | | | | liquid 1 | |
| liquid 16 | | | | | | |
| Overcoat | ACM2 | BYK-UV3570 | 1.30 | 2.26 | ITO | 38 |
| layer | | | | | dispersion | |
| coating | | | | | liquid 1 | |
| liquid 17 | | | | | | |
| Overcoat | ACM2 | BYK-UV3570 | 1.7 | 0.64 | ITO | 38 |
| layer | | | | | dispersion | |
| coating | | | | | liquid 1 | |
| liquid 18 | | | | | | |
| Overcoat | ACM2 | BYK-UV3570 | 1.73 | 2.60 | ITO | 38 |
| layer | | | | | dispersion | |
| coating | | | | | liquid 1 | |
| liquid 19 | | | | | | |
| Overcoat | ACM2 | BYK-310 | 0.50 | 0.42 | ITO | 38 |
| layer | | | | | dispersion | |
| coating | | | | | liquid 1 | |
| liquid 20 | | | | | | |
| Overcoat | ACM2 | BYK-313 | 0.50 | 0.42 | ITO | 38 |
| layer | | | | | dispersion | |
| coating | | | | | liquid 1 | |
| liquid 21 | | | | | | |
| Overcoat | ACM2 | BYK-315N | 0.50 | 0.42 | ITO | 38 |
| layer | | | | | dispersion | |
| coating | | | | | liquid 1 | |
| liquid 22 | | | | | | |
| Overcoat | ACM2 | BYK-370 | 0.50 | 0.42 | ITO | 38 |
| layer | | | | | dispersion | |
| coating | | | | | liquid 1 | |
| liquid 23 | | | | | | |
| Overcoat | ACM2 | BYK-UV3570 | 0.71 | 0.64 | SnO2 | 76 |
| layer | | | | | dispersion | |
| coating | | | | | liquid | |
| liquid 24 | | | | | | |
| Overcoat | ACM2 | BYK-UV3570 | 0.71 | 0.64 | TiO2 | 104 |
| layer | | | | | dispersion | |
| coating | | | | | liquid | |
| liquid 25 | | | | | | |
| Overcoat | ACM56 (A-9550, | BYK-UV3570 | 0.71 | 0.64 | ITO | 38 |
| layer | manufactured by | | | | dispersion | |
| coating | SHIN-NAKAMURA | | | | liquid 1 | |
| liquid 26 | CHEMICAL Co., Ltd.) | | | | | |
| Overcoat | ACM19 (TMPTA, | BYK-UV3570 | 0.71 | 0.64 | ITO | 38 |
| layer | manufactured by | | | | dispersion | |
| coating | DAICEL-ALLNEX | | | | liquid 1 | |
| liquid 27 | LTD.) | | | | | |
| Overcoat | ACM55 | BYK-UV3570 | 0.65 | 0.65 | — | — |
| layer | | | | | | |
| coating | | | | | | |
| liquid 28 | | | | | | |
| Overcoat | ACM2 | BYK-UV3570 | 0.72 | 0.00 | ITO | 38 |
| layer | | | | | dispersion | |
| coating | | | | | liquid 5 | |
| liquid 29 | | | | | | |
| Overcoat | ACM2 | BYK-UV3500 | 0.16 | 0.00 | ITO | 38 |
| layer | | (Polyether modified | | | dispersion | |
| coating | | polydimethylsiloxane) | | | liquid 1 | |
| liquid 30 | | | | | | |
| Overcoat | ACM2 | BYK-UV3570 | 2.26 | 0.00 | ITO | 38 |
| layer | | | | | dispersion | |
| coating | | | | | liquid 5 | |
| liquid 31 | | | | | | |
| Overcoat | ACM2 | BYK-UV3570 | 0.71 | 0.62 | ITO | 45 |
| layer | | | | | dispersion | |
| coating | | | | | liquid 1 | |
| liquid 32 | | | | | | |
| Overcoat | ACM2 | BYK-UV3570 | 0.71 | 0.57 | ITO | 70 |
| layer | | | | | dispersion | |
| coating | | | | | liquid 1 | |
| liquid 33 | | | | | | |
| Overcoat | ACM2 | BYK-UV3570 | 0.71 | 0.54 | ITO | 85 |
| layer | | | | | dispersion | |
| coating | | | | | liquid 1 | |
| liquid 34 | | | | | | |
| Overcoat | Plyophen J-325CA | BYK-310 | 0.71 | 0.64 | ITO | 38 |
| layer | (manufactured by DIC | | | | dispersion | |
| coating | Corporation) | | | | liquid 1 | |
| liquid 35 | | | | | | |

The results obtained by measuring the volume resistivity of each metal oxide particle used in Table 1 according to <Method for measuring volume resistivity of metal oxide particle> are shown in Table 2.

TABLE 2

| Mox type | Volume resistivity (Ω · cm) |
|---|---|
| ITO | 1.2 × 10⁻¹ |
| SnO₂ | 5.4 × 10³ |
| TiO₂ | 3.8 × 10⁸ |

In Table 1 and Table 2, “ITO” represents “indium tin oxide”, “SnO₂” represents “tin(II) oxide”, and “TiO₂” represents “titanium(IV) oxide (titania)”.

### <Production of Electrophotographic Photosensitive Member>

### (Production Example of Electrophotographic Photosensitive Member 1)

An aluminum cylinder (JIS-A3003, aluminum alloy) having a length of 257 mm and a diameter of 24 mm produced by a production method including an extrusion step and a drawing step was prepared. The aluminum cylinder was subjected to cutting using a diamond sintered bit.

As the washing step, the cylinder was sequentially subjected to degreasing treatment, etching treatment with a 2% by mass sodium hydroxide solution for 1 minute, neutralization treatment, and further, pure water washing.

Thereafter, the cylinder was subjected to anodization in a 10% by mass sulfuric acid solution at a current density of 1.0 A/dm² for 20 minutes to form an anodized film on the cylinder surface. Thereafter, the resultant was washed with water, and then subjected to sealing treatment by being immersed in a 1% by mass nickel acetate solution at 80° C. for 15 minutes. Further, the resultant was washed with pure water and subjected to drying treatment to obtain a support subjected to anodization treatment.

The charge generation layer coating liquid was applied on the support by dip coating to form a coating film, and the coating film was heated and dried at 100° C. for 15 minutes, whereby a charge generation layer having a film thickness of 0.24 μm was formed.

Thereafter, the charge transport layer coating liquid 1 was applied on the above charge generation layer by dip coating to form a coating film, and the coating film was heated and dried at 120° C. for 1 hour, whereby a charge transport layer having a film thickness of 18 μm was formed.

Thereafter, the overcoat layer coating liquid 1 was applied on the above charge transport layer by dip coating to form a coating film, and the coating film was irradiated with an electron beam with a dose of 86 kGy, and naturally cooled in an atmosphere until a temperature of the coating film reached 25° C. Then, the resultant was subjected to heat treatment for 1 hour under the conditions where the temperature of the coating film reached 120° C. to form an overcoat layer having a film thickness of 1.5 μm.

The heat treatment of the coating film of each layer was carried out using an oven set to each temperature. A cylindrical (drum-shaped) electrophotographic photosensitive member 1 was produced as above.

### (Production Examples of Electrophotographic Photosensitive Members 2 to 36 and 38)

Electrophotographic photosensitive members 2 to 36 and 38 were produced in the same manner as Production Example of the electrophotographic photosensitive member 1, except that, in Production Example of the electrophotographic photosensitive member 1, a type of the photosensitive layer coating liquid and a type of the overcoat layer coating liquid were changed as described in Table 3. In the electrophotographic photosensitive members having no description about the overcoat layer in Table 3, no overcoat layer is formed, and the photosensitive layer is the surface layer.

### (Production Example of Electrophotographic Photosensitive Member 37)

The electrophotographic photosensitive member 37 was produced in a same manner as Production Example of the electrophotographic photosensitive member 1, except that the following method was used as the method for forming the overcoat layer.

### [Method for Forming Overcoat Layer of Electrophotographic Photosensitive Member 37]

The charge transport layer coating liquid 37 was applied on the charge transport layer by dip coating, and the obtained coating film was dried and thermally cured at 150° C. for 30 minutes to form a first overcoat layer having a film thickness of 1.5 μm.

### <Sampling of Electrophotographic Photosensitive Member Surface Layer>

Sampling of the surface layer of the electrophotographic photosensitive member was carried out using a micromanipulator (Axis Pro SS, manufactured by Micro Support Co., Ltd.). Then, it was confirmed that sampling depth was same as the film thickness of the surface layer.

### <Measurement of Specific Gravity of Surface Layer>

The specific gravity of the sampled surface layer was measured by pycnometry (a liquid-phase substitution method) using butanol as a dispersion solvent.

### <Measurement of Content of Metal Particles in Surface Layer>

The proportion of volume of the metal oxide particle based on total volume of the surface layer was calculated from an amount to be added, density and true specific gravity of the monomer having a polymerizable functional group and particle used in the surface layer coating liquid. The specific gravity of the polymers and particle after polymerization of the monomer having a polymerizable functional group can be referred to suppliers of respective materials and published values in database POLYINFO of National Institute for Materials Science.

When the proportion is determined from the electrophotographic photosensitive member, for example, the following method is used.

The cross-section observation of the electrophotographic photosensitive member produced in Example was carried out. The samples subjected to the cross-section observation were obtained by equally dividing the electrophotographic photosensitive member into four pieces in a longitudinal direction, and collecting samples at positions which are ¼, ½ and ¾ of the lengths from the end part and are each shifted by 120° in a circumferential direction. 5 mm-square sample pieces were cut out from each electrophotographic photosensitive member, and 2 μm×2 μm×2 μm of the surface layer was made three-dimensional by Slice & View of FIB-SEM.

The conditions of Slice & View were as follows.
Sample processing for analysis: FIB method
Processing and observation apparatus: NVision 40 manufactured by SII/Zeiss
Slice interval: 5 nm

### (Observation Condition)

Accelerating voltage: 1.0 kV
Sample inclination: 540
WD: 5 mm
Detector: BSE detector
Aperture: 60 m, high current
ABC: ON
Image resolution: 1.25 nm/pixel

A measurement environment was set at a temperature of 23° C. and a pressure of 1×10-4 Pa. As the processing and observation apparatus, Strata 400S manufactured by FEI (sample inclination: 52°) may also be used.

An analysis area was 2 μm in length×2 μm in width, information was integrated for every cross-section, and the volume V per 2 μm in length×2 μm in width×2 μm in thickness (8 μm³) on the surface of the surface layer was determined. The image analysis for each cross-section was carried out using an image processing software: Image-Pro Plus manufactured by Media Cybernetics, Inc.

A content of the particle based on total volume of the surface layer was calculated according to the difference in contrast in Slice & View of FIB-SEM. The volume V of the particle of the present invention in a volume of 2 μm×2 μm×2 μm (unit volume: 8 μm³) was determined for each of four sample pieces based on the information obtained from the image analysis, and a content of the particle [% by volume](=V μm3/8 μm³×100) was calculated. An average value of the values of the content of the particle in each sample piece was set as the content V [% by volume] of each particle of the present invention in the surface layer based on the total volume of the surface layer.

With respect to the specific gravity α of the surface layer calculated above, the content V [% by volume] of the metal oxide particle in the surface layer based on the total volume of the surface layer, and the specific gravity γ_{M} of the metal oxide particle and the specific gravity γᵣ of a part [resin part] excluding the metal oxide in the surface layer, the following expression 1 holds up. Thus, the specific gravity γᵣ of the part [resin part] excluding the metal oxide in the surface layer was calculated from the specific gravity α of the surface layer, the specific gravity γ_{M} of the metal oxide particle and the content V [% by volume] of the metal oxide particle. For the identification of the metal oxide particle, published values in database POLYINFO of National Institute for Materials Science were used as the specific gravity, as described below.

a=V×γ_{M}+(1−V)×γᵣ (Expression 1)

### <HS-GCMS>

After weight of the surface layer sampled from the electrophotographic photosensitive member was measured (X g) in advance, the surface layer sampled was put in a headspace vial, which was sealed with a septum. The sealed headspace vial was heated under the following conditions, and the vaporized oleamide was measured using GC/MS under the following conditions. The peak area at which oleamide was detected in the obtained total ion chromatogram was determined. A calibration curve was produced using a solution obtained by dissolving oleamide in methanol as the reference material for the calibration curve, and an amount of oleamide detected (A (g)) was calculated from the above peak area. The oleamide content (A/X (%)) was calculated by dividing the amount detected (A (g)) by the weight of the sample cut out (X (g)).

### [Pretreatment Conditions]

### <Headspace Sampler Conditions>

Triplus 300 (manufactured by Thermo Fisher Scientific K.K.), heating temperature: 150° C., retention time: 60 minutes, measurement times: once

### <GC/MS Analysis Conditions>

GC: TRACEGC 1310, MS: ISQ-LT, carrier gas: He, injection mode: split (split flow 20 mL/min), column flow rate: 1 mL/min (constant flow mode), separation column: DB-5MS (length: 60 m, internal diameter: 0.25 mm, film thickness: 0.25 μm), oven temperature: a temperature was held at 40° C. for 3 minutes, subsequently heated at a temperature rising rate of 2° C./min to 70° C., subsequently heated at a temperature rising rate of 5° C./min to 150° C., subsequently heated at a temperature rising rate of 10° C./min to 300° C., and then held at 300° C. for 1 minute. MS: ion chamber temperature: 250° C., ionization method: EI, ionization voltage: 70 eV, measurement mode: scan, mass range: m/z=25 to 401 GC/MS interface temperature: 250° C.

### <¹H-NMR Analysis>

Weight of the surface layer sampled from the electrophotographic photosensitive member was measured (X2 g) in advance, and the surface layer was then immersed in chloroform so that the entire surface layer was dipped and allowed to stand still for 10 minutes, whereby all the polyester-modified polydimethylsiloxane formed on the surface layer was eluted.

The solution was distilled off under reduced pressure to dryness. To the dried product, 1 g of deuterated chloroform (manufactured by Sigma-Aldrich Japan, chloroform-d 99.8 atom % D, contains 0.05% (v/v) TMS) containing tetramethylsilane as the internal reference material was added, and the mixture was stirred by shaking for 5 minutes to completely dissolve the dried product.

The solution was transferred to an NMR sample tube made of glass having an outer diameter of 5 mm (ST500-7 manufactured by Norell, Inc.), and proton NMR measurement was conducted. For the NMR apparatus, AVANCE500 manufactured by Bruker was used. Measurement conditions were set to automatic measurement by ICON-NMR except that a cumulative number was set to 32 times and rotational speed was set to 20 Hz. In the obtained spectrum, chemical shift value of a peak of methyl group in tetramethylsilane was corrected to 0 ppm.

An amount of the polyester-modified polydimethylsiloxane detected (B (g)) was calculated from a peak intensity ratio with tetramethylsilane serving as an internal reference material. The content of the polyester-modified polydimethylsiloxane (B/X2(%)) was calculated by dividing the amount detected (B (g)) by the weight of the sample cut out (X2 (g)).

### <Method for Identifying (Meth)Acrylic Compound>

Whether the electrophotographic photosensitive member used in the present invention has a surface layer formed by polymerizing the composition containing a (meth)acrylic compound can be identified as follows. In addition, the structural formulas and content ratios of a plurality of types of (meth)acrylic monomers and/or (meth)acrylic oligomers can be identified as follows.
(1) The electrophotographic photosensitive member is dipped in chloroform. Since the surface layer formed by polymerizing a (meth)acrylic compound is insoluble in chloroform, the surface layer is separated from the electrophotographic photosensitive member in chloroform, and a chloroform dissolution in which layers lower than the surface layer are dissolved is obtained.
(2) The above dissolution is analyzed using chromatography, accurate mass spectrometry, nuclear magnetic resonance spectroscopy, pyrolytic gas chromatography or etc. Thus, a plurality of types of unreacted (meth)acrylic monomers and/or (meth)acrylic oligomers contained in the layers lower than the surface layer is identified.
(3) A certain amount of the above plurality of types of (meth)acrylic monomers and/or (meth)acrylic oligomers identified is prepared, for example, by synthesis or through purchases, and the (meth)acrylic monomers and/or (meth)acrylic oligomers are singly polymerized.
(4) Each of the above plurality of types of polymers polymerized is analyzed by infrared spectroscopy, and a calibration peak is determined as a peak used to obtain a calibration curve in the obtained infrared absorption spectrum. In this case, a calibration peak of each (meth)acrylic monomer is selected so that a peak intensity is maximum under the conditions where no calibration peak of a polymer other than itself falls within a range three times larger than the full width at half maximum of the calibration peak.
(5) For each polymer, a calibration range defined by a range three times larger than the full width at half maximum centered around the calibration peak is determined.
(6) Infrared absorption spectrum when at least two or more of unreacted (meth)acrylic monomers and/or (meth)acrylic oligomers are mixed at at least two or more mixing ratios and polymerized are measured. Then, integral values in the above calibration range are compared, and a calibration curve is obtained for each (meth)acrylic monomer and/or (meth)acrylic oligomer.
(7) The surface layer of the electrophotographic photosensitive member to be identified is analyzed by infrared spectroscopy. Based on the obtained infrared absorption spectrum-1 and calibration curves of each (meth)acrylic monomer and/or (meth)acrylic oligomer, a mixing ratio of each (meth)acrylic monomer and/or (meth)acrylic oligomer contained in the surface layer is calculated.
(8) Infrared absorption spectrum-2 of a polymer obtained by mixing and polymerizing each (meth)acrylic monomer and/or (meth)acrylic oligomer at the above mixing ratio is measured.
(9) The above infrared absorption spectrum-1 and the above infrared absorption spectrum-2 are compared. Then, it is confirmed that an integral value of a differential spectrum in a calibration range of each (meth)acrylic monomer and/or (meth)acrylic oligomer is 10% or less of the integral value in the calibration range of the above infrared absorption spectrum-2.

The procedures (1) and (2) in the above identification method can be replaced with component identification using other methods including document searching. It is only required to be confirmed that, eventually in the above procedure (9), the surface layer to be identified is certainly polymerized from a plurality of types of (meth)acrylic monomers and/or (meth)acrylic oligomers which are candidates to be identified. In this case, the procedures (3) to (8) can also be replace with other methods, in addition to (1) and (2).

### <Method for Identifying Metal Oxide Particle>

When the surface layer of the electrophotographic photosensitive member used in the present invention contains a metal oxide particle, formulation of the metal oxide particle, and the proportion of the content of the metal oxide particle based on the surface layer can be identified as follows.

### (Identification of Formulation)

(1) A cross-section of the surface layer of the electrophotographic photosensitive member is cut out and observed by a scanning electron microscope.
(2) A particle present on the observed range is subjected to energy dispersive X-ray analysis to identify the formulation of the particle.

### (Identification of Content)

(1) The electrophotographic photosensitive member is dipped in chloroform. Since the surface layer formed by polymerizing a (meth)acrylic compound is insoluble in chloroform, the surface layer is separated from the electrophotographic photosensitive member in chloroform.
(2) The above separated surface layer is washed, then dried, and subjected to thermogravimetric analysis.
(3) By comparing the weight at low temperature and the weight at high temperature after all the organic matters are burned, the content is identified.

### <Method for Measuring Volume Resistivity of Metal Oxide Particle>

The volume resistivity of the metal oxide particle can be evaluated by measuring the electrostatic capacity and electrical conductivity of air and powder by impedance measurement using a parallel plate capacitor method.

For the apparatus, a powder measurement jig formed of a four-terminal sample holder SH2-Z (manufactured by TOYO Corporation) and a torque wrench adapter SH-TRQ-AD (manufactured by TOYO Corporation, option), and a material test system ModuLab XM MTS (manufactured by Solartron Metrology) are used. A noise cutoff transformer NCT-I3 1.4 kVA for suppressing commercial power supply noise (manufactured by DENKENSEIKI Research Institute Co., Ltd.) and a shield box for suppressing electromagnetic wave noise are used.

For the powder measurement jig, a four-terminal sample holder and a torque wrench adapter SH-TRQ-AD which is an option of the sample holder are used. As a parallel plate electrode, an upper electrode (Φ 25 mm solid electrode) SH-H25AU and a lower electrode for fluid/powder (center electrode Φ 10 mm; guard electrode Φ 26 mm) SH-2610AU are used.

Consequently, a configuration that enables a resistance of 0.1Ω to 1 TΩ with respect to an electrical signal (500 Vp-p maximum, DC to AC 1 MHz) to be measured is obtained. To adjust the pressure of the powder sample, a torque wrench adapter SH-TRQ-AD is attached to micrometer that is provided on a four-terminal sample holder and to be used for measuring film thickness between the upper and lower electrodes.

As a torque driver to be used for pressurization control, torque drivers RTD15CN and RTD30CN (manufactured by Tohnichi Mfg. Co., Ltd.), and a 6.35 mm square bit are used, and a configuration that enables the tightening torque for the metal oxide particle to be controlled to 20.0 cN/m is obtained.

In the measurement of electrical AC characteristics, impedance measurement is conducted using the material test system ModuLab XM MTS (manufactured by Solartron Metrology). ModuLab XM MTS is formed from a control module XM MAT 1 MHz, a high voltage module XM MHV100, a femto current module XM MFA, and a frequency response analysis module XM MRA 1 MHz. For a control software, XM-studio MTS Ver. 3.4 manufactured by Solartron Metrology is used.

The measurement conditions of the metal oxide particle is Normal Mode in which only measurement is carried out. The AC level is set within a range of 7×10⁻³ Vrms or more and 7 Vrms or less so as to be a current range that is measurable by a measurement instrument.

The DC bias is set to 0 V, and the sweep frequency is set to 1 MHz to 0.01 Hz (12 points/decade or 6 points/decade). In a case of a powder material having high conductivity, such as an external additive, the AC level is set within a range of 7×10⁻³ Vrms or more and 7 Vrms or less so as to be a current range that is measurable by the measurement instrument.

Further, in view of suppression of noise and shortening of measurement time, the following settings are added for each sweep frequency.
Sweep frequency 1 MHz to 10 Hz: measured integration time 64 cycles
Sweep frequency 10 Hz to 1 Hz: measured integration time 24 cycles
Sweep frequency 1 Hz to 0.01 Hz: measured integration time 1 cycles

The measurement of impedance characteristics as electrical AC characteristics is conducted according to the above measurement conditions.

By carrying out measurement under the above conditions and using powder measurement jig based on parallel plate capacitor method, an impedance characteristics of air and a sample at a film thickness d according to a Φ 10 mm measurement electrode S and a pressurized torque can be obtained.

The obtained impedance characteristics of air and the sample were subjected to data correction treatment of the measurement system to obtain highly reliable electrostatic capacity C and conductance (conductivity) G. Relative permittivity and electrical conductivity as electrical characteristics are determined from the obtained electrostatic capacity C and conductance (conductivity) G, and the geometric shape of the powder measurement jig (the electrode size S of the parallel plate and the sample film thickness).

When the four-terminal sample holder SH2-Z is used for the first time, it is required to conduct the following two tests for finding optimal measurement conditions. This is because the four-terminal sample holder SH2-Z to be used in the powder measurement jig has an individual difference.

A first test is for the film thickness dependent characteristics of the four-terminal sample holder. The thickness (distance between upper and lower electrodes) dependence of air is measured, an error between the theoretical value and the measured value of the electrostatic capacity is confirmed, and an optimal range at which the measurement error is minimum or a film thickness at which an optimal value is obtained is grasped.

A second test is the measurement of a mechanical error. To keep the volume density constant, a torque-controlled load is applied in the measurement of the powder sample. In contrast, the measurement of air is performed in an unloaded state.

Then, a film thickness error occurs due to influence by a dimension such as mechanical processing accuracy. Thus, an offset value between a state loaded with the tightening torque-collected value (in the present jig, 6.5 cN·m) and an unloaded state is confirmed, and the value is used as the offset correction value.

Specific production and measurement procedures of the sample are as follows.
(1) A powder sample is put on the center electrode part of the lower electrode, and formed so as to be a trapezoidal shape having a height of 5 mm.
(2) The lower electrode on which the powder sample is put is attached to the four-terminal sample holder SH2-Z, and the upper electrode is lowered.
(3) Then, the upper electrode is lowered to a top part of the powder sample, while keeping the upper electrode constant so as not to be carelessly rotated.
(4) While rotating the upper electrode leftward and rightward, smoothing treatment is carried out so that the powder sample can be smooth.
(5) A rotation direction of the upper electrode is kept in a certain uniform direction, while adjusting the film thickness so as to be a predetermined film thickness using the micrometer.
(6) The powder sample is pressurized using a torque driver in which tightening torque is controlled to 20.0 cN·m.
(7) The film thickness of the powder sample is measured using a micrometer.
(8) An impedance measurement is conducted under the above conditions.
(9) After the measurement is terminated, the upper electrode is elevated, and the lower electrode is removed. Then, the lower electrode is very carefully removed so that the powder sample is not entered into the contact terminal for the lower electrode of the four-terminal sample holder, and the lower electrode is protected with a masking tape.
(10) The upper and lower electrodes are washed.
(11) The masking tape is removed, and the lower electrode is attached.
(12) The thickness is adjusted so as to be an air thickness t considering an offset correction in an unloaded state for sample film thickness d determined in the step (7), and a rotation direction of the upper electrode is kept in a certain uniform direction.
(13) The impedance measurement of air is conducted.
(14) When the measurement data (dielectric loss tangent; tan δ) of air measured in the step (13) is more than 0.001 in a frequency range of 100 Hz to 0.021 Hz, washing is insufficient. Thus, the operation is started from the washing step in the step (10) over again.

The measurement is conducted at 25° C.

Specific data treatment procedures are as follows.
(15) An error in phase characteristics with respect to a theoretical value is calculated from the measured impedance characteristics of air, and a phase correction data of the material test system ModuLab XM MTS (manufactured by Solartron Metrology) is obtained.
(16) A phase correction data calculated in the step (15) is applied to the impedance characteristics of air measured in the step (13), and impedance characteristics of air subjected to phase correction treatment are obtained.
(17) An electrostatic capacity Ca is calculated from admittance Ya=Ga+jωCa of the impedance characteristics of air subjected to phase correction, an error from the theoretical value is calculated, and a correction data a for the film thickness error is obtained.
(18) The phase correction treatment obtained in the step (15) is applied to the impedance characteristics of the powder sample measured in the step (8).
(19) Highly reliable relative permittivity and electrical conductivity of the powder sample can be obtained through calculation for the complex admittance Ym=Gm+jωCm of the characteristics subjected to the phase correction treatment in the step (18) using electrostatic capacity Ca of air determined in the step (17) and the correction data a thereof.

Hereinafter, a method for quantifying volume resistivity as an electrical characteristic will be described.

### (Method for Quantifying Conductivity Index κ/ω)

Typically, since electrical conductivity κ of a dielectric material (insulating material) has a characteristic proportional to an angular frequency, it is useful for a conductive parameter value to use conductivity index κ/ω obtained by dividing the electrical conductivity κ by angular frequency ω. The conductivity index κ/ω) exhibits similar frequency characteristics as dielectric loss tangent tan δ, and a characteristic of having a maximum value is obtained when the dielectric relaxation of an electrode interface component is different from the dielectric relaxation of a powder bulk component.

It is considered that a maximum value of the conductivity index κ/ω exhibits conductivity to the powder bulk including an inside of the particle, the particle surface and the (particle-particle) interface. Thus, the maximum value is defined as the conductivity parameter of the powder bulk component.

### (Method for Quantifying Electrical Conductivity and Volume Resistivity)

The powder sample having both electrostatic capacity and conductivity can be recognized as an RC parallel circuit model, and the electrical conductivity κ in a low frequency range exhibits a certain value. An inverse of the electrical conductivity κ is defined as volume resistivity.

### <Measurement of Martens Hardness of Surface Layer>

The Martens hardness of the surface layer was measured using a micro hardness measurement apparatus (trade name: PICODENTOR HM500, manufactured by FISCHER INSTRUMENTS K.K.) and a microscope provided on the apparatus.

Specifically, using the microscope provided on the micro hardness measurement apparatus in a 25° C./50% RH environment, the Martens hardness was measured by bringing a square pyramid shaped diamond indenter into contact with the core part specified in an observation of a hollow particle by a confocal microscope, pressing an indenter under the conditions of pushing speed of the following equation 1, and allowing the surface layer to creep at a maximum contact pressure of 0.5 mN for 5 seconds.

dF/dt=0.5 mN/10 s (Equation 1)

In the equation 1, F represents a force, and t represents a time.

As the Martens hardness, hardness at a creep time of 5 seconds was extracted. The measurement was carried out at 10 points, and the extracted values were averaged, whereby an average value of the Martens hardness of the surface layer was obtained.

TABLE 3

| | | | | | Polydimethylsiloxane | | |
|---|---|---|---|---|---|---|---|
| | | | | | | Content | |
| | | | | | | in | |
| | Overcoat layer | | Photosensitive layer | | | surface | Amount of oleamide |
| | Overcoat | | Charge | | | layer | per 100 parts by |
| Electrophotographic | layer | Film | transport | Film | | resin | mass of |
| photosensitive | coating | thickness | layer coating | thickness | | (% by | polydimethylsiloxane |
| member No | liquid No | (μm) | liquid No | (μm) | Type | mass) | (parts by mass) |
| Electrophotographic | Overcoat | 1.5 | Charge | 18.0 | BYK- | 0.44 | 100 |
| photosensitive | layer | | transport | | UV3570 | | |
| member 1 | coating | | layer coating | | | | |
| | liquid 1 | | liquid 1 | | | | |
| Electrophotographic | Overcoat | 1.5 | Charge | 18.0 | BYK- | 0.45 | 42 |
| photosensitive | layer | | transport | | UV3570 | | |
| member 2 | coating | | layer coating | | | | |
| | liquid 2 | | liquid 1 | | | | |
| Electrophotographic | Overcoat | 1.5 | Charge | 18.0 | BYK- | 0.45 | 155 |
| photosensitive | layer | | transport | | UV3570 | | |
| member 3 | coating | | layer coating | | | | |
| | liquid 3 | | liquid 1 | | | | |
| Electrophotographic | Overcoat | 1.5 | Charge | 18.0 | BYK- | 0.07 | 30 |
| photosensitive | layer | | transport | | UV3570 | | |
| member 4 | coating | | layer coating | | | | |
| | liquid 4 | | liquid 1 | | | | |
| Electrophotographic | Overcoat | 1.5 | Charge | 18.0 | BYK- | 0.07 | 160 |
| photosensitive | layer | | transport | | UV3570 | | |
| member 5 | coating | | layer coating | | | | |
| | liquid 5 | | liquid 1 | | | | |
| Electrophotographic | Overcoat | 1.5 | Charge | 18.0 | BYK- | 0.11 | 29 |
| photosensitive | layer | | transport | | UV3570 | | |
| member 6 | coating | | layer coating | | | | |
| | liquid 6 | | liquid 1 | | | | |
| Electrophotographic | Overcoat | 1.5 | Charge | 18.0 | BYK- | 0.11 | 44 |
| photosensitive | layer | | transport | | UV3570 | | |
| member 7 | coating | | layer coating | | | | |
| | liquid 7 | | liquid 1 | | | | |
| Electrophotographic | Overcoat | 1.5 | Charge | 18.0 | BYK- | 0.11 | 103 |
| photosensitive | layer | | transport | | UV3570 | | |
| member 8 | coating | | layer coating | | | | |
| | liquid 8 | | liquid 1 | | | | |
| Electrophotographic | Overcoat | 1.5 | Charge | 18.0 | BYK- | 0.11 | 155 |
| photosensitive | layer | | transport | | UV3570 | | |
| member 9 | coating | | layer coating | | | | |
| | liquid 9 | | liquid 1 | | | | |
| Electrophotographic | Overcoat | 1.5 | Charge | 18.0 | BYK- | 0.11 | 179 |
| photosensitive | layer | | transport | | UV3570 | | |
| member 10 | coating | | layer coating | | | | |
| | liquid 10 | | liquid 1 | | | | |
| Electrophotographic | Overcoat | 1.5 | Charge | 18.0 | BYK- | 0.14 | 33 |
| photosensitive | layer | | transport | | UV3570 | | |
| member 11 | coating | | layer coating | | | | |
| | liquid 11 | | liquid 1 | | | | |
| Electrophotographic | Overcoat | 1.5 | Charge | 18.0 | BYK- | 0.14 | 156 |
| photosensitive | layer | | transport | | UV3570 | | |
| member 12 | coating | | layer coating | | | | |
| | liquid 12 | | liquid 1 | | | | |
| Electrophotographic | Overcoat | 1.5 | Charge | 18.0 | BYK- | 0.80 | 31 |
| photosensitive | layer | | transport | | UV3570 | | |
| member 13 | coating | | layer coating | | | | |
| | liquid 13 | | liquid 1 | | | | |
| Electrophotographic | Overcoat | 1.5 | Charge | 18.0 | BYK- | 0.80 | 42 |
| photosensitive | layer | | transport | | UV3570 | | |
| member 14 | coating | | layer coating | | | | |
| | liquid 14 | | liquid 1 | | | | |
| Electrophotographic | Overcoat | 1.5 | Charge | 18.0 | BYK- | 0.79 | 100 |
| photosensitive | layer | | transport | | UV3570 | | |
| member 15 | coating | | layer coating | | | | |
| | liquid 15 | | liquid 1 | | | | |
| Electrophotographic | Overcoat | 1.5 | Charge | 18.0 | BYK- | 0.80 | 155 |
| photosensitive | layer | | transport | | UV3570 | | |
| member 16 | coating | | layer coating | | | | |
| | liquid 16 | | liquid 1 | | | | |
| Electrophotographic | Overcoat | 1.5 | Charge | 18.0 | BYK- | 0.79 | 180 |
| photosensitive | layer | | transport | | UV3570 | | |
| member 17 | coating | | layer coating | | | | |
| | liquid 17 | | liquid 1 | | | | |
| Electrophotographic | Overcoat | 1.5 | Charge | 18.0 | BYK- | 1.06 | 42 |
| photosensitive | layer | | transport | | UV3570 | | |
| member 18 | coating | | layer coating | | | | |
| | liquid 18 | | liquid 1 | | | | |
| Electrophotographic | Overcoat | 1.5 | Charge | 18.0 | BYK- | 1.05 | 155 |
| photosensitive | layer | | transport | | UV3570 | | |
| member 19 | coating | | layer coating | | | | |
| | liquid 19 | | liquid 1 | | | | |
| Electrophotographic | Overcoat | 1.5 | Charge | 18.0 | BYK-310 | 0.45 | 100 |
| photosensitive | layer | | transport | | | | |
| member 20 | coating | | layer coating | | | | |
| | liquid 20 | | liquid 1 | | | | |
| Electrophotographic | Overcoat | 1.5 | Charge | 18.0 | BYK-313 | 0.45 | 100 |
| photosensitive | layer | | transport | | | | |
| member 21 | coating | | layer coating | | | | |
| | liquid 21 | | liquid 1 | | | | |
| Electrophotographic | Overcoat | 1.5 | Charge | 18.0 | BYK-315N | 0.45 | 100 |
| photosensitive | layer | | transport | | | | |
| member 22 | coating | | layer coating | | | | |
| | liquid 22 | | liquid 1 | | | | |
| Electrophotographic | Overcoat | 1.5 | Charge | 18.0 | BYK-370 | 0.45 | 100 |
| photosensitive | layer | | transport | | | | |
| member 23 | coating | | layer coating | | | | |
| | liquid 23 | | liquid 1 | | | | |
| Electrophotographic | Overcoat | 1.5 | Charge | 18.0 | BYK- | 0.45 | 100 |
| photosensitive | layer | | transport | | UV3570 | | |
| member 24 | coating | | layer coating | | | | |
| | liquid 24 | | liquid 1 | | | | |
| Electrophotographic | Overcoat | 1.5 | Charge | 18.0 | BYK- | 0.45 | 100 |
| photosensitive | layer | | transport | | UV3570 | | |
| member 25 | coating | | layer coating | | | | |
| | liquid 25 | | liquid 1 | | | | |
| Electrophotographic | Overcoat | 1.5 | Charge | 18.0 | BYK- | 0.44 | 100 |
| photosensitive | layer | | transport | | UV3570 | | |
| member 26 | coating | | layer coating | | | | |
| | liquid 26 | | liquid 1 | | | | |
| Electrophotographic | Overcoat | 1.5 | Charge | 18.0 | BYK- | 0.44 | 100 |
| photosensitive | layer | | transport | | UV3570 | | |
| member 27 | coating | | layer coating | | | | |
| | liquid 27 | | liquid 1 | | | | |
| Electrophotographic | Overcoat | 1.5 | Charge | 18.0 | BYK- | 0.45 | 100 |
| photosensitive | layer | | transport | | UV3570 | | |
| member 28 | coating | | layer coating | | | | |
| | liquid 28 | | liquid 1 | | | | |
| Electrophotographic | — | — | Charge | 19.5 | BYK-310 | 0.20 | 100 |
| photosensitive | | | transport | | | | |
| member 29 | | | layer coating | | | | |
| | | | liquid 3 | | | | |
| Electrophotographic | Overcoat | 1.5 | Charge | 18.0 | BYK- | 0.44 | 100 |
| photosensitive | layer | | transport | | UV3570 | | |
| member 34 | coating | | layer coating | | | | |
| | liquid 32 | | liquid 1 | | | | |
| Electrophotographic | Overcoat | 1.5 | Charge | 18.0 | BYK- | 0.41 | 100 |
| photosensitive | layer | | transport | | UV3570 | | |
| member 35 | coating | | layer coating | | | | |
| | liquid 33 | | liquid 1 | | | | |
| Electrophotographic | Overcoat | 1.5 | Charge | 18.0 | BYK- | 0.40 | 100 |
| photosensitive | layer | | transport | | UV3570 | | |
| member 36 | coating | | layer coating | | | | |
| | liquid 34 | | liquid 1 | | | | |
| Electrophotographic | Overcoat | 1.5 | Charge | 18.0 | BYK-310 | 0.45 | 100 |
| photosensitive | layer | | transport | | | | |
| member 37 | coating | | layer coating | | | | |
| | liquid 35 | | liquid 1 | | | | |
| Electrophotographic | — | — | Charge | 19.5 | BYK-310 | 0.20 | 100 |
| photosensitive | | | transport | | | | |
| member 38 | | | layer coating | | | | |
| | | | liquid 4 | | | | |
| Electrophotographic | — | — | Charge | 19.5 | BYK-310 | 0.20 | 0 |
| photosensitive | | | transport | | | | |
| member 30 | | | layer coating | | | | |
| | | | liquid 2 | | | | |
| Electrophotographic | Overcoat | 1.5 | Charge | 18.0 | BYK- | 0.45 | 0 |
| photosensitive | layer | | transport | | UV3570 | | |
| member 31 | coating | | layer coating | | | | |
| | liquid 29 | | liquid 1 | | | | |
| Electrophotographic | Overcoat | 1.5 | Charge | 18.0 | BYK- | 0.10 | 48 |
| photosensitive | layer | | transport | | UV3500 | | |
| member 32 | coating | | layer coating | | | | |
| | liquid 30 | | liquid 1 | | | | |
| Electrophotographic | Overcoat | 1.5 | Charge | 19.0 | BYK- | 1.40 | 0 |
| photosensitive | layer | | transport | | UV3570 | | |
| member 33 | coating | | layer coating | | | | |
| | liquid 31 | | liquid 2 | | | | |

TABLE 4

| | Surface layer | | Proportion of volume of |
|---|---|---|---|
| | Martens | Specific | metal oxide particle |
| | hardness | gravity | based on total volume of |
| Electrophotographic photosensitive member No | [N/mm²] | [g/cm³] | surface layer |
| Electrophotographic photosensitive member 1 | 250 | 1.30 | 1.83 |
| Electrophotographic photosensitive member 2 | 250 | 1.30 | 1.84 |
| Electrophotographic photosensitive member 3 | 250 | 1.30 | 1.82 |
| Electrophotographic photosensitive member 4 | 250 | 1.30 | 1.85 |
| Electrophotographic photosensitive member 5 | 250 | 1.30 | 1.85 |
| Electrophotographic photosensitive member 6 | 250 | 1.30 | 1.85 |
| Electrophotographic photosensitive member 7 | 250 | 1.30 | 1.85 |
| Electrophotographic photosensitive member 8 | 250 | 1.30 | 1.85 |
| Electrophotographic photosensitive member 9 | 250 | 1.30 | 1.85 |
| Electrophotographic photosensitive member 10 | 250 | 1.30 | 1.85 |
| Electrophotographic photosensitive member 11 | 250 | 1.30 | 1.85 |
| Electrophotographic photosensitive member 12 | 250 | 1.30 | 1.84 |
| Electrophotographic photosensitive member 13 | 250 | 1.30 | 1.82 |
| Electrophotographic photosensitive member 14 | 250 | 1.30 | 1.82 |
| Electrophotographic photosensitive member 15 | 250 | 1.30 | 1.80 |
| Electrophotographic photosensitive member 16 | 250 | 1.30 | 1.79 |
| Electrophotographic photosensitive member 17 | 250 | 1.30 | 1.78 |
| Electrophotographic photosensitive member 18 | 250 | 1.30 | 1.81 |
| Electrophotographic photosensitive member 19 | 250 | 1.30 | 1.77 |
| Electrophotographic photosensitive member 20 | 250 | 1.30 | 1.83 |
| Electrophotographic photosensitive member 21 | 250 | 1.30 | 1.83 |
| Electrophotographic photosensitive member 22 | 250 | 1.30 | 1.83 |
| Electrophotographic photosensitive member 23 | 250 | 1.30 | 1.83 |
| Electrophotographic photosensitive member 24 | 250 | 1.40 | 1.88 |
| Electrophotographic photosensitive member 25 | 375 | 1.49 | 7.98 |
| Electrophotographic photosensitive member 26 | 200 | 1.30 | 1.83 |
| Electrophotographic photosensitive member 27 | 190 | 1.30 | 1.83 |
| Electrophotographic photosensitive member 28 | 185 | 1.30 | 0 |
| Electrophotographic photosensitive member 29 | 150 | 1.20 | 0 |
| Electrophotographic photosensitive member 34 | 260 | 1.32 | 2.16 |
| Electrophotographic photosensitive member 35 | 280 | 1.38 | 3.31 |
| Electrophotographic photosensitive member 36 | 300 | 1.42 | 3.99 |
| Electrophotographic photosensitive member 37 | 330 | 1.30 | 1.82 |
| Electrophotographic photosensitive member 38 | 130 | 1.20 | 0 |
| Electrophotographic photosensitive member 30 | 150 | 1.20 | 0 |
| Electrophotographic photosensitive member 31 | 250 | 1.30 | 1.84 |
| Electrophotographic photosensitive member 32 | 250 | 1.30 | 1.85 |
| Electrophotographic photosensitive member 33 | 250 | 1.30 | 1.82 |

### <Evaluation Method>

### <Evaluation Method of Image Blurring>

Examples and Comparative Examples were evaluated by the following evaluation method.

A photosensitive member testing apparatus (trade name: CYNTHIA59, manufactured by GENTEC CO., LTD.) was used. Each electrophotographic photosensitive member of Examples and Comparative Examples were installed on the photosensitive member testing apparatus in an environment of a temperature of 32.5° C./a humidity of 80% RH, and aged for 24 hours or more.

In addition, a charging apparatus was set using a conductive rubber roller having a diameter of 8 mm as a charging member so that a rectangular wave voltage having a frequency of 1 Hz, Voffset=−450 V and Vpp=500 V can be applied to a surface of the electrophotographic photosensitive member.

In the potential measurement, a surface potential probe (model 6000B-8: manufactured by Trek Japan K.K.) was installed on a position 1 mm apart from the electrophotographic photosensitive member, and a surface potential meter (model 344: manufactured by Trek Japan K.K.) was used.

According to the following procedures 1 to 4, the initial charge retainability was determined.
Procedure 1: While rotating the electrophotographic photosensitive member at a rotational speed of 30 rpm in an environment of a temperature of 32.5° C. and a humidity of 80% RH, a voltage is applied to the surface of the electrophotographic photosensitive member in one direction. The voltage is a rectangular wave having a frequency of 1 Hz, Voffset=−450 V, and Vpp=1,000 V.
Procedure 2: In a position where a part on the surface of the electrophotographic photosensitive member applied with the voltage is rotated for 0.30 seconds, the potential of the surface of the electrophotographic photosensitive member is measured at a measurement interval of 100 s for a certain time of 10 seconds or more and 20 seconds or less.
Procedure 3: The values obtained from the measurement are plotted by setting the unit of the abscissa axis as s and the unit of the ordinate axis as V, and with respect to each measurement point, each inclination of a regression line derived from former 25 measurement points and a regression line derived from latter 25 measurement points is determined.
Procedure 4: Among the obtained inclination values, absolute values of maximum values and minimum values are averaged, and calculated value is defined as charge retainability.

In the above Procedure 3, with respect to the initial 24 points obtained from an initiation of the measurement and 24 points before a termination of the measurement, the measurement point for deriving the regression line is less than 25, and thus, these points are not used as the data for determining the inclination.

Then, the electrophotographic photosensitive member is subjected to discharge idle rotation for 10 minutes under the following conditions. A voltage is applied to the electrophotographic photosensitive member surface while rotating the electrophotographic photosensitive member at 60 rpm. The voltage is a rectangular wave having a frequency of 1.4 kHz, Voffset=−450 V, and Vpp=1,300 V.

After discharge idle rotation is conducted, charge retainability after discharge deterioration is measured again according to the above Procedures 1 to 4 in a same manner as the measurement of initial charge retainability.

A numerical value obtained by subtracting the charge retainability after discharge deterioration from initial charge retainability was calculated as image blurring suppression index.

The results are shown in Table 5.

### <Evaluation of Cleanability>

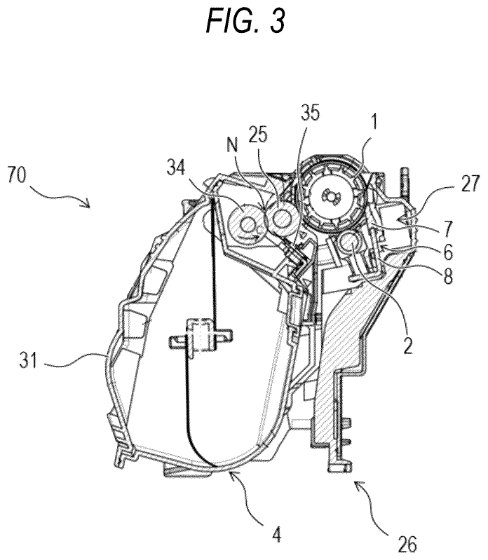

For the evaluation of cleanability, a laser beam printer (trade name: Color Laser Jet Enterprise M653dn) manufactured by HP Development Company, L.P. and the process cartridge mounted with the electrophotographic photosensitive member produced in the present invention illustrated in FIG. 3 as a schematic diagram were used.

Charge potential was set to −550 V and exposure potential was set to −100 V in an environment of a temperature or 15.0° C. and a relative humidity of 10%, and a 1% printing image using black toner was sequentially passed (printed) for 10,000 times. The first one image and images for every 1,000 images, 11 images in total were evaluated according to the following evaluation criteria. Evaluation criteria up to C is in a level without any practical problem. Evaluation results are shown in Table 4.

### (Evaluation Criteria)

A: In visual observation, no stripe-like image extending in the process direction is confirmed in 11 images in total.
B: In visual observation, there are 5 or less stripe-like images extending in the process direction in 11 images in total, and all stripes have a length of 5 mm or less.
C: In visual observation, there are 5 or less stripe-like images extending in the process direction in 11 images in total, and one or more stripes have a length of more than 5 mm.
D: In visual observation, more than 5 stripe-like images extending in the process direction are confirmed in 11 images in total.

### <Evaluation of Charging Roller-Contacted Stripe>

For the evaluation of a charging roller pitch stripe, a laser beam printer (trade name: Color Laser Jet Enterprise M653dn) manufactured by HP Development Company, L.P. and the process cartridge mounted with the electrophotographic photosensitive member produced in the present invention illustrated in FIG. 2 as a schematic diagram were used.

The process cartridge mounted with the electrophotographic photosensitive member produced in the present invention was put in a sealed bag and installed in an environment of a temperature of 40° C. and a relative humidity of 95%. After 2 hours from the installation, the bag was opened, further allowed to stand for 7 days, and then allowed to stand in an environment of a temperature of 25° C. and a relative humidity of 50% for 24 hours.

To enable the contact portion of the charging roller and the electrophotographic photosensitive member to be determined, marks were put on the charging roller and the electrophotographic photosensitive member with a marker. Then, to output an evaluation image, the voltage applied to the charging roller was set first so that the surface potential of the electrophotographic photosensitive member was −550 V, and a half-tone image using black toner and having a margin of 5.0 mm both in vertical and horizontal directions (amount of toner applied: 0.2 mg/cm²) was printed.

An evaluation of the charging roller-contacted stripe image of the half-tone image was carried out according to the following evaluation criteria. Evaluation criteria A to C are in a level without any practical problem. Evaluation results are shown in Table 5.

### (Evaluation Criteria)

A: In visual observation, no charging roller pitch stripe is observed on the image.
B: In visual observation, a part of a contact portion of the charging roller and the electrophotographic photosensitive member is very slightly observed on the image, but the part is not observed in a cycle of an outer circumference of the charging roller or the electrophotographic photosensitive member.
C: In visual observation, a part of the contact portion of the charging roller and the electrophotographic photosensitive member is very slightly observed on the image, and the part is confirmed with a pitch of the outer circumference of the charging roller or the electrophotographic photosensitive member.
D: In visual observation, a part of the contact portion of the charging roller and the electrophotographic photosensitive member is observed on the image, and the part is confirmed with a pitch of the outer circumference of the charging roller or the electrophotographic photosensitive member.
E: In visual observation, almost all parts of the contact portion of the charging roller and the electrophotographic photosensitive member is observed on the image, and their parts are confirmed with a pitch of the outer circumference of the charging roller or the electrophotographic photosensitive member.

TABLE 5

| | | | | Charg- |
|---|---|---|---|---|
| | | | | ing |
| | | Image | | roller |
| | Electrophotographic | blurring | Clean- | pitch |
| Example | photosensitive member | suppressed | ing | stripe |
| No | No | index | rank | rank |
| Example 1 | Electrophotographic | 0.8 | A | A |
| | photosensitive member 1 | | | |
| Example 2 | Electrophotographic | 1.7 | A | A |
| | photosensitive member 2 | | | |
| Example 3 | Electrophotographic | 0.7 | A | C |
| | photosensitive member 3 | | | |
| Example 4 | Electrophotographic | 1.0 | C | A |
| | photosensitive member 4 | | | |
| Example 5 | Electrophotographic | 0.7 | C | B |
| | photosensitive member 5 | | | |
| Example 6 | Electrophotographic | 1.2 | B | A |
| | photosensitive member 6 | | | |
| Example 7 | Electrophotographic | 1.1 | B | A |
| | photosensitive member 7 | | | |
| Example 8 | Electrophotographic | 0.8 | B | A |
| | photosensitive member 8 | | | |
| Example 9 | Electrophotographic | 0.7 | B | B |
| | photosensitive member 9 | | | |
| Example 10 | Electrophotographic | 0.7 | B | B |
| | photosensitive member 10 | | | |
| Example 11 | Electrophotographic | 1.3 | B | A |
| | photosensitive member 11 | | | |
| Example 12 | Electrophotographic | 0.7 | B | B |
| | photosensitive member 12 | | | |
| Example 13 | Electrophotographic | 2.0 | A | A |
| | photosensitive member 13 | | | |
| Example 14 | Electrophotographic | 1.8 | A | A |
| | photosensitive member 14 | | | |
| Example 15 | Electrophotographic | 1.0 | A | A |
| | photosensitive member 15 | | | |
| Example 16 | Electrophotographic | 0.8 | A | B |
| | photosensitive member 16 | | | |
| Example 17 | Electrophotographic | 0.7 | A | C |
| | photosensitive member 17 | | | |
| Example 18 | Electrophotographic | 1.8 | A | A |
| | photosensitive member 18 | | | |
| Example 19 | Electrophotographic | 1.0 | A | C |
| | photosensitive member 19 | | | |
| Example 20 | Electrophotographic | 0.8 | B | A |
| | photosensitive member 20 | | | |
| Example 21 | Electrophotographic | 0.8 | B | A |
| | photosensitive member 21 | | | |
| Example 22 | Electrophotographic | 0.8 | B | A |
| | photosensitive member 22 | | | |
| Example 23 | Electrophotographic | 0.8 | B | A |
| | photosensitive member 23 | | | |
| Example 24 | Electrophotographic | 0.8 | A | A |
| | photosensitive member 24 | | | |
| Example 25 | Electrophotographic | 0.8 | A | A |
| | photosensitive member 25 | | | |
| Example 26 | Electrophotographic | 0.8 | C | A |
| | photosensitive member 26 | | | |
| Example 27 | Electrophotographic | 0.8 | A | A |
| | photosensitive member 27 | | | |
| Example 28 | Electrophotographic | 1.0 | A | A |
| | photosensitive member 28 | | | |
| Example 29 | Electrophotographic | 1.2 | C | A |
| | photosensitive member 29 | | | |
| Example 30 | Electrophotographic | 1.5 | A | A |
| | photosensitive member 34 | | | |
| Example 31 | Electrophotographic | 2.0 | A | A |
| | photosensitive member 35 | | | |
| Example 32 | Electrophotographic | 2.9 | B | A |
| | photosensitive member 36 | | | |
| Example 33 | Electrophotographic | 0.8 | C | A |
| | photosensitive member 37 | | | |
| Example 34 | Electrophotographic | 1.8 | C | A |
| | photosensitive member 38 | | | |
| Comparative | Electrophotographic | 3.2 | C | A |
| Example 1 | photosensitive member 30 | | | |
| Comparative | Electrophotographic | 5.0 | A | A |
| Example 2 | photosensitive member 31 | | | |
| Comparative | Electrophotographic | 2.8 | D | A |
| Example 3 | photosensitive member 32 | | | |
| Comparative | Electrophotographic | 5.8 | A | D |
| Example 4 | photosensitive member 33 | | | |

According to the present invention, the electrophotographic photosensitive member can suppress the occurrence of image blurring also in a high-temperature and high-humidity environment, while maintaining high cleanability also in a high-speed electrophotographic apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-053994, filed Mar. 28, 2024, and Japanese Patent Application No. 2025-022740, filed Feb. 14, 2025, which are hereby incorporated by reference herein in their entirety.

What is claimed is:

1. An electrophotographic photosensitive member comprising a surface layer comprising a binder resin, wherein
the surface layer comprises a polydimethylsiloxane having a polyester chain, and oleamide.

2. The electrophotographic photosensitive member according to claim 1, wherein
the surface layer is an overcoat layer, and
the overcoat layer is a polymer film of a composition comprising at least one (meth)acrylic compound selected from the group consisting of a (meth)acrylic monomer and a (meth)acrylic oligomer.

3. The electrophotographic photosensitive member according to claim 2, wherein the polydimethylsiloxane having a polyester chain is a part of the polymer film in the overcoat layer.

4. The electrophotographic photosensitive member according to claim 2, wherein the composition comprising the (meth)acrylic compound comprises at least one selected from the group consisting of a hexafunctional urethane acrylic monomer and a hexafunctional urethane acrylic oligomer.

5. The electrophotographic photosensitive member according to claim 1, wherein Martens hardness of the surface layer is 150 N/mm² or more and 300 N/mm² or less.

6. The electrophotographic photosensitive member according to claim 1, wherein the surface layer comprises a metal oxide particle.

7. The electrophotographic photosensitive member according to claim 6, wherein the metal oxide particle contains a tin atom.

8. The electrophotographic photosensitive member according to claim 6, wherein the metal oxide particle is an ITO particle.

9. The electrophotographic photosensitive member according to claim 1, wherein an amount of the oleamide added is 40 parts by mass or more and 160 parts by mass or less, based on 100 parts by mass of the polydimethylsiloxane having a polyester chain.

10. The electrophotographic photosensitive member according to claim 1, wherein the polydimethylsiloxane having a polyester chain is polyester-modified polydimethylsiloxane.

11. The electrophotographic photosensitive member according to claim 1, wherein the polydimethylsiloxane having a polyester chain is a compound represented by the following formula (B): 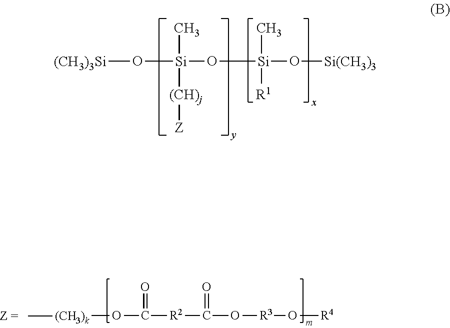
wherein R¹ is an aliphatic hydrocarbon group having 1 or more and 15 or less carbon atoms, R² is an aliphatic hydrocarbon group having 1 or more and 15 or less carbon atoms or an aromatic hydrocarbon group, R³ is an aliphatic hydrocarbon group having 1 or more and 15 or less carbon atoms or an aromatic hydrocarbon group, R⁴ is an aliphatic hydrocarbon group having 1 or more and 15 or less carbon atoms or an aromatic hydrocarbon group, x is an integer of 1 to 300, y is an integer of 1 to 100, j is an integer of 1 to 15, k is an integer of 0 to 5, and m is an integer of 1 to 20.

12. A process cartridge integrally supporting:
an electrophotographic photosensitive member having a surface layer comprising a binder resin, wherein the surface layer comprises a polydimethylsiloxane having a polyester chain, and oleamide; and
at least one unit selected from the group consisting of a charging unit, a developing unit and a cleaning unit,
the process cartridge being detachable from the body of an electrophotographic apparatus.

13. An electrophotographic apparatus having an electrophotographic photosensitive member having a surface layer comprising a binder resin, wherein the surface layer comprises a polydimethylsiloxane having a polyester chain, and oleamide; a charging unit; an exposure unit; a developing unit; and a transfer unit.

14. A method for producing an electrophotographic photosensitive member having a surface layer, the method comprising:
preparing a coating liquid for the surface layer;
applying the coating liquid; and
solidifying the applied coating liquid by drying or curing,
wherein the coating liquid comprises a polydimethylsiloxane having a polyester chain, and oleamide.
